(19) United States
(12) Patent Application Publication
(10) Pub. No.: US 2026/0059574 A1
(43) Pub. Date: Feb. 26, 2026

(54) TERMINAL, RADIO COMMUNICATION METHOD, AND BASE STATION

(71) Applicant: NTT DOCOMO, INC., Tokyo (JP)

(72) Inventors: Naoya SHIBAIKE, Tokyo (JP); Yuki MATSUMURA, Tokyo (JP); Satoshi NAGATA, Tokyo (JP); Qiping PI, Beijing (CN); Jing WANG, Beijing (CN); Lan CHEN, Beijing (CN)

(73) Assignee: NTT DOCOMO, INC., Tokyo (JP)

(21) Appl. No.: 19/100,222

(22) PCT Filed: Aug. 5, 2022
(86) PCT No.: PCT/JP2022/030128

§ 371 Date: Jan. 31, 2025

(51) Int. Cl. H04W 74/0833; H04B 17/318; H04W 56/00

(52) U.S. Cl. CPC H04W 74/0833; H04B 17/328; H04W 56/0015

(57) ABSTRACT

A terminal according to one aspect of the present disclosure includes a control section that determines one transmission scheme from among a first transmission scheme for transmitting a physical random access channel (PRACH) without a plurality of repetitions, a second transmission scheme for transmitting the plurality of repetitions by using the same beam, a third transmission scheme for transmitting the plurality of repetitions by using a plurality of different beams, and a fourth transmission scheme for transmitting the plurality of repetitions by using the same beam and a plurality of different beams, and a transmitting section that transmits one or more PRACHs by using the transmission scheme. According to one aspect of the present disclosure, it is possible to improve coverage for random access procedure.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP (registered trademark)) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (for example, NR), improvement of coverage is under study.

However, random access procedure for the coverage improvement remains unclear. Unless such random access procedure is made clear, communication throughput may deteriorate.

Thus, an object of the present disclosure is to provide a terminal, a radio communication method, and a base station that improve coverage for random access procedure.

### Solution to Problem

A terminal according to one aspect of the present disclosure includes a control section that determines one transmission scheme from among a first transmission scheme for transmitting a physical random access channel (PRACH) without a plurality of repetitions, a second transmission scheme for transmitting the plurality of repetitions by using the using a same beam, a third transmission scheme for transmitting the plurality of repetitions by using a plurality of different beams, and a fourth transmission scheme for transmitting the plurality of repetitions by using the using a same beam and a plurality of different beams, and a transmitting section that transmits one or more PRACHs by using the transmission scheme.

### Advantageous Effects of Invention

According to one aspect of the present disclosure, it is possible to improve coverage for random access procedure.

### BRIEF DESCRIPTION OF DRAWINGS

FIG. 1 shows an example of a RACH configuration information element.

FIGS. 2A and 2B show examples of PRACH repetitions with the using the same beam.

FIGS. 3A and 3B show examples of PRACH repetitions with a plurality of different beams.

FIGS. 4A and 4B show examples of operation allowed in Option 4/Option 3.

FIGS. 5A and 5B show examples of Choice 3-8.

FIG. 6 shows a first example of operation for Operation A/C in Choice 4-8.

FIG. 7 shows a second example of the operation for Operation A/C in Choice 4-8.

FIG. 8 shows a third example of the operation for Operation A/C in Choice 4-8.

FIG. 9 shows a fourth example of the operation for Operation A/C in Choice 4-8.

FIG. 10 shows a first example of operation for Operation B/D in Choice 4-8.

FIG. 11 shows a second example of the operation for Operation B/D in Choice 4-8.

FIG. 12 is a diagram to show an example of a schematic structure of a radio communication system according to one embodiment.

FIG. 13 is a diagram to show an example of a structure of a base station according to one embodiment.

FIG. 14 is a diagram to show an example of a structure of a user terminal according to one embodiment.

FIG. 15 is a diagram to show an example of a hardware structure of the base station and the user terminal according to one embodiment.

FIG. 16 is a diagram to show an example of a vehicle according to one embodiment.

### DESCRIPTION OF EMBODIMENTS

### (TCI, Spatial Relation, QCL)

For NR, it is studied that reception processing (for example, at least one of reception, demapping, demodulation, and decoding) and transmission processing (for example, at least one of transmission, mapping, precoding, modulation, and coding) of at least one of a signal and a channel (expressed as a signal/channel) in a UE are controlled based on a transmission configuration indication state (TCI state).

The TCI state may be a state applied to a downlink signal/channel. A state that corresponds to the TCI state applied to an uplink signal/channel may be expressed as spatial relation.

The TCI state is information related to quasi-co-location (QCL) of the signal/channel, and may be referred to as a spatial reception parameter, spatial relation information, or the like. The TCI state may be configured for the UE for each channel or for each signal.

QCL is an indicator indicating statistical properties of the signal/channel. For example, when a given signal/channel and another signal/channel are in a relationship of QCL, it may be indicated that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

For the QCL, a plurality of types (QCL types) may be defined. For example, four QCL types A to D may be provided, which have different parameter(s) (or parameter set(s)) that can be assumed to be the same, and such parameter(s) (which may be referred to as QCL parameter(s)) are described below:

```
  - QCL type A (QCL-A): Doppler shift, Doppler spread, average
delay, and delay spread
  - QCL type B (QCL-B): Doppler shift and Doppler spread
  - QCL type C (QCL-C): Doppler shift and average delay
  - QCL type D (QCL-D): Spatial reception parameter
```

A case that the UE assumes that a given control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (in other words, a reference signal (RS) for the channel) and another signal (for example, another RS). The TCI state may be configured (indicated) by higher layer signaling or physical layer signaling, or a combination of these.

The physical layer signaling may be, for example, downlink control information (DCI).

A channel for which the TCI state or spatial relation is configured (specified) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS to have a QCL relationship with the channel may be, for example, at least one of a synchronization signal block (SSB), a channel state information reference signal (CSI-RS), a reference signal for measurement (Sounding Reference Signal (SRS)), a CSI-RS for tracking (also referred to as a Tracking Reference Signal (TRS)), and a reference signal for QCL detection (also referred to as a QRS).

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

An RS of QCL type X in a TCI state may mean an RS in a relationship of QCL type X with (a DMRS of) a given channel/signal, and this RS may be referred to as a QCL source of QCL type X in the TCI state.

### (Initial Access Procedure)

In initial access procedure, the UE (RRC_IDLE mode) performs reception of an SS/PBCH block (SSB), transmission of Msg. 1 (PRACH/random access preamble/preamble), reception of Msg. 2 (PDCCH, PDSCH including a random access response (RAR)), transmission of Msg. 3 (PUSCH scheduled by an RAR UL grant), and reception of Msg. 4 (PDCCH, PDSCH including UE contention resolution identity). Subsequently, when an ACK for Msg. 4 is transmitted from the UE by a base station (network), an RRC connection is established (RRC_CONNECTED mode).

The reception of the SSB includes PSS detection, SSS detection, PBCH-DMRS detection, and PBCH reception. The PSS detection performs detection of part of a physical cell ID (PCI), detection (synchronization) of an OFDM symbol timing, and (rough) frequency synchronization. The SSS detection includes detection of the physical cell ID. The PBCH-DMRS detection includes detection of (part of) an SSB index in a half radio frame (5 ms). The PBCH reception includes detection of a system frame number (SFN) and a radio frame timing (SSB index), reception of configuration information for remaining minimum system information (RMSI, SIB1) reception, and recognition of whether the UE can camp on that cell (carrier).

The SSB includes a band of 20 RBs and time of 4 symbols. A transmission periodicity of the SSB is configurable with {5, 10, 20, 40, 80, 160} ms. In the half frame, a plurality of symbol locations of the SSB are defined based on a frequency range (FR1, FR2).

The PBCH includes a 56-bit payload. N repetitions of the PBCH are transmitted in a periodicity of 80 ms. N depends on the transmission periodicity of the SSB.

The system information consists of an MIB, RMSI (SIB1), and other system information (OSI) delivered by the PBCH. The SIB1 includes RACH configuration and information for performing RACH procedure. A time/frequency resource relationship between the SSB and a PDCCH monitoring resource for the SIB1 is configured by the PBCH.

The base station that uses beam correspondence transmits a plurality of SSBs by using a plurality of respective beams every SSB transmission periodicity. The plurality of SSBs include a plurality of respective SSB indices. The UE that has detected one SSB transmits a PRACH in a RACH occasion associated with the SSB index, and receives an RAR in an RAR window.

### (Beam and Coverage)

In a high frequency band, unless beam forming is applied to a synchronization signal/reference signal, coverage becomes narrow, and it is difficult for the UE to identify the base station. On the other hand, applying the beam forming to the synchronization signal/reference signal to secure coverage allows a strong signal to be delivered in a specific direction, but makes it more difficult for signals to be delivered in directions other than that direction. Assuming that a direction of the presence of the UE is unknown in the base station before the UE is connected, transmission of the synchronization signal/reference signal using a beam only in an appropriate direction is unavailable. A conceivable method is a method in which the base station transmits a plurality of synchronization signals/reference signals including respective beams in different directions, and recognizes which beam is identified by the UE.

Using thin (narrow) beams for coverage requires transmission of many synchronization signals/reference signals, and thus overhead may increase, and frequency use efficiency may be reduced.

Using a thick (wide) beam to suppress overhead by reducing the number of beams (synchronization signals/reference signals) narrows coverage.

In future radio communication systems (for example, 6G), it is conceivable that use of frequency bands, such as millimeter waves and terahertz waves, advances further. It is conceivable that communication services are provided by developing a cell area/coverage by using multiple thin beams.

Area expansion using existing FR2 and use of a higher frequency band than existing FR2 are conceivable. For achieving these, improvement in beam management in addition to multi-TRP, reconfigurable intelligent surface (RIS), and the like is preferable.

Coverage enhancement including PRACH enhancement for frequency range (FR) 2 is under study. For example, PRACH repetitions using the using the same beam or a plurality of different beams are under study. The PRACH enhancement may be applied to FR1.

The PRACH enhancement may be applied to a short PRACH format or may be applied to another format.

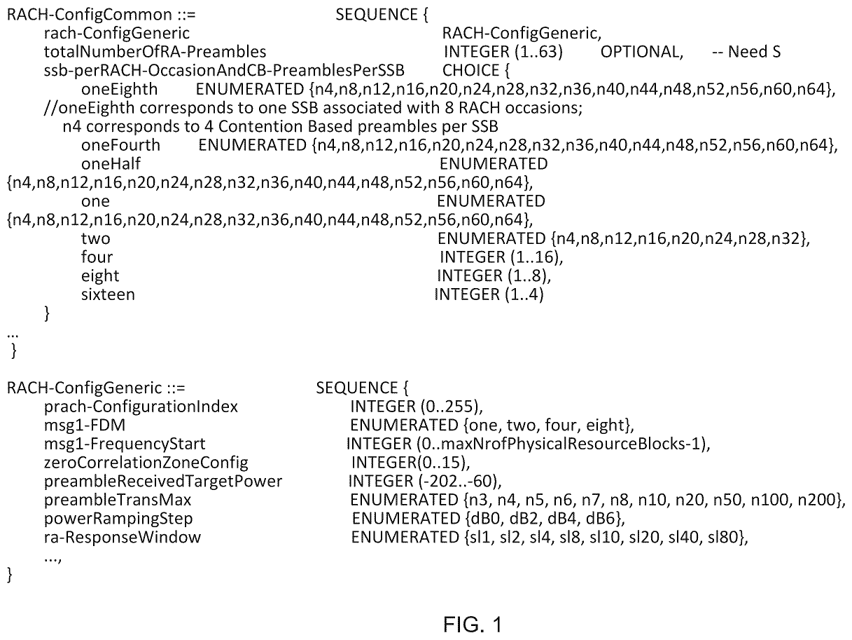

As shown in FIG. 1, common RACH configuration (RACH-ConfigCommon) may include generic RACH configuration (rach-ConfigGeneric), a total number of RA preambles (totalNumberOfRA-Preambles), and an SSB per RACH occasion and contention-based (CB) preambles per SSB (ssb-perRACH-OccasionAndCB-PreamblesPerSSB). rach-ConfigGeneric may include a PRACH configuration index (prach-ConfigurationIndex) and message 1 FDM (msgl-FDM, the number of PRACH occasions FDMed in one time instance). ssb-perRACH-OccasionAndCB-PreamblesPerSSB may include, for the number of SSBs per RACH occasion 1/8 (oneEighth, one SSB being associated with 8 RACH occasions), the number of CB preambles per SSB.

For type 1 random access procedure (4-step random access procedure, message 1/2/3/4), the number N of SS/PBCH blocks associated with one PRACH occasion and the number R of CB preambles per valid PRACH occasion or per SS/PBCH block may be applied for the UE by ssb-perRACH-OccasionAndCB-PreamblesPerSSB.

For the type 1 random access procedure or for type 2 random access procedure (2-step random access procedure, message A/B) with PRACH occasion configuration independent of the type 1 random access procedure, if N<1, one SS/PBCH block is mapped to 1/N consecutive valid RACH occasions, and R CB preambles with consecutive indices associated with an SS/PBCH block index for each valid PRACH occasion start from preamble index 0. If N≥1, R CB preambles with consecutive indices associated with SS/PBCH block index n (0≤n≤N−1) for each valid PRACH occasion start from preamble index n·N_preamble\hat{ }total/N. Here, N_preamble\hat{ }total is given by totalNumberOfRA-Preambles for the type 1 random access procedure, and is given by msgA-TotalNumberOfRA-Preambles for the type 2 random access procedure with the PRACH occasion configuration independent of the type 1 random access procedure. N_preamble\hat{ }total is a multiple of N.

An association period, starting from frame 0, for mapping SS/PBCH blocks to PRACH occasions is a minimum value in a set determined by a PRACH configuration period in accordance with a relationship (relationship defined in a specification) between a PRACH configuration period and an association period (the number of PRACH configuration periods) so that N_Tx\hat{ }SSB SS/PBCH block indices are mapped to PRACH occasions at least one time in the association period. Here, the UE obtains N_Tx\hat{ }SSB from values of SSB positions in a burst (ssb-PositionsInBurst) in SIB1 or in common serving cell configuration (ServingCellConfigCommon). If a set of PRACH occasions or PRACH preambles not mapped to N_Tx\hat{ }SSB SS/PBCH block indices is present after an integer number of cycles of mapping from SS/PBCH block indices to PRACH occasions in the association period, none of the SS/PBCH block indices is mapped to the set of PRACH occasions or PRACH preambles. An association pattern period includes one or more association periods, and is determined so that a pattern between PRACH occasions and SS/PBCH block indices is repeated every at most 160 ms. If a PRACH occasion not associated with SS/PBCH block indices after an integer number of association periods is present, the PRACH occasion is not used for a PRACH.

For PRACH configuration periods 10, 20, 40, 80, and 160 [msec], association periods are {1, 2, 4, 8, 16}, {1, 2, 4, 8}, {1, 2, 4}, [1, 2], and {1}, respectively.

When ssb-perRACH-OccasionAndCB-PreamblesPerSSB for an association between a PRACH occasion (RACH occasion (RO)) and a beam (SSB/CSI-RS) indicates oneHalf, n16 (N=1/2, R=16), and msgl-FDM is 4, four ROs are FDMed in one time instance, and one SSB is mapped to two ROs. Preamble indices 0 to 15 are associated with two ROs, and preamble indices 0 to 15 are associated with SSOB. Thus, when N<1, one SSB is mapped to a plurality of ROs. Therefore, RO capacity per beam can be enhanced.

When ssb-perRACH-OccasionAndCB-PreamblesPerSSB indicates n4, n16 (N=4, R=16), msgl-FDM is 4, and N_preamble\hat{ }total is 64, four ROs are FDMed in one time instance, and four SSBs are mapped to one RO. One RO is associated with SSBs 0 to 3. Preamble indices 0 to 15, preamble indices 15 to 31, preamble indices 32 to 47, and preamble indices 48 to 63 are associated with SSB 0, SSB 1, SSB 2, SSB 2 and SSB 3, respectively. Thus, the same RO is associated with different SS/PBCH block indices, and different preambles use different SS/PBCH block indices. The base station can distinguish between the associated SS/PBCH block indices by using a received PRACH.

The random access preamble can be transmitted only in a time resource defined in random access configuration in a specification, and depends on whether the random access preamble is based on FR1 or FR2, and a spectrum type (paired spectrum/supplementary uplink (SUL)/unpaired spectrum). The PRACH configuration index is given by a higher layer parameter “prach-ConfigurationIndex” or by “msgA-PRACH-ConfigurationIndex,” if configured. In the specification, respective values of the PRACH configuration index are associated with at least one of preamble formats, x and y in n_f (frame number) mod x=y, subframe numbers, start symbols, the numbers of PRACH slots in a subframe, the numbers N_t\hat{ }RA,slot of time domain PRACH occasions in a PRACH slot, and PRACH duration N_dur\hat{ }RA.

A type of the RACH procedure triggered by different purposes varies depending on whether PRACH repetitions are applicable to a scenario. The type of the RACH procedure may be at least one of the following.
Contention-free random access (CFRA), PDCCH order RA (PDCCH ordered RA, RA initiated by PDCCH order), CFRA for beam failure recovery (BFR), CFRA for system information (SI) request, CFRA for reconfiguration with synchronization (reconfiguration with sync), and the like
Contention-based random access (CBRA), RA triggered by MAC entity, RA triggered by RRC with event, CBRA for BFR, and the like
4-step RACH
2-step RACH

However, configuration/procedure for the PRACH repetitions remains unclear. For example, how to configure PRACH resources for the repetitions (for example, a repetition pattern and the number of repetitions), UE operation for preamble repetition transmission, an impact on a RACH-related counter/timer, and the like remains unclear. Unless such configuration/procedure is made clear, communication quality/communication throughput may deteriorate.

### (RA Response Window)

An RA response window (ra-ResponseWindow) is a time window for monitoring an RA response (RAR) (only for a special cell (SpCell)). An RA contention resolution timer (ra-ContentionResolutionTimer) is a timer for RA contention resolution (only for the SpCell). A Msg.B response window is a time window for monitoring an RA response (RAR) for a 2-step RA type (only for the SpCell).

In the present disclosure, the SpCell, a primary cell (PCell), and a primary secondary cell (PSCell) may be interchangeably interpreted.

When an RA preamble is transmitted, a MAC entity performs Operations 1 to 3 below irrespective of a possibility of occurrence of a measurement gap.

### {Operation 1}

If a contention-free RA preamble for a BFR request is transmitted by the MAC entity, the MAC entity performs Operations 1-1 and 1-2 below.

{{Operation 1-1}} The MAC entity starts, in the first PDCCH occasion since an end of the RA preamble transmission, ra-ResponseWindow configured in BFR configuration (BeamFailureRecoveryConfig).
{{Operation 1-2}} While ra-ResponseWindow is operating, the MAC entity monitors PDCCH transmission in a search space indicated by a BFR search space ID (recoverySearchSpaceId) of an SpCell identified by a C-radio network temporary identifier (RNTI).

### {Operation 2}

Otherwise, the MAC entity performs Operations 2-1 and 2-2 below.

{{Operation 2-1}} The MAC entity starts, in the first PDCCH occasion since an end of the RA preamble transmission, ra-ResponseWindow configured in common RACH configuration (RACH-ConfigCommon).
{{Operation 2-2}} While ra-ResponseWindow is operating, the MAC entity monitors PDCCH transmission in an RAR SpCell identified by an RA-RNTI.

### {Operation 3}

If ra-ResponseWindow configured in BeamFailureRecoveryConfig has expired, and PDCCH transmission on the search space indicated by recoverySearchSpaceId for the C-RNTI has been received on a serving cell in which the preamble has been transmitted or if ra-ResponseWindow configured in RACH-ConfigCommon has expired, and an EAR including RA preamble identifiers matching a transmitted preamble index (PREAMBLE_INDEX) has been received, the MAC entity assumes that the RAR reception is unsuccessful, and increments a preamble transmission counter (PREAMBLE_TRANSMISSION_COUNTER) by 1.

The MAC entity may stop ra-ResponseWindow after success in receiving an RAR including RA preamble identifiers matching the transmitted PREAMBLE_INDEX (may stop monitoring for the RAR).

For PDCCH monitoring in the RA response window, there are two cases of a PDCCH for a base station response to BFR and a PDCCH for an RAR. The following description may be employed in both of the cases.

When an MSGA (Msg.A) preamble is transmitted, a MAC entity performs Operations 4 to 6 below irrespective of a possibility of occurrence of a measurement gap.

### {Operation 4}

The MAC entity starts, in a PDCCH monitoring window defined in a specification, a Msg.B response window (msgB-ResponseWindow).

msgB-ResponseWindow may be started in the first symbol of the earliest CORESET in which the UE is configured with reception of a PDCCH for a type 1-PDCCH CSS set that is at least one symbol after the last symbol of a PRACH occasion corresponding to PRACH transmission. A length of msgB-ResponseWindow may correspond to SCS for the type 1-PDCCH CSS set.

### {Operation 5}

While msgB-ResponseWindow is operating, the MAC entity monitors PDCCH transmission in an PAR SpCell identified by an MSGB-RNTI.

### {Operation 6}

If the MSGA includes a C-RNTI MAC CE, while msgB-ResponseWindow is operating, the MAC entity monitors PDCCH transmission in an RAR SpCell identified by a C-RNTI.

The RA-RNTI associated with a PRACH occasion in which the RA preamble is transmitted is calculated as follows.

$$RA - RNTI = 1 + s\_id + 14 \times t\_id + 14 \times 80 \times f\_id + 14 \times 80 \times 8 \times ul\_carrier \_id$$

Here, s_id is an index of the first OFDM symbol of the PRACH occasion (0≤s_id<14). t_id is an index of the first slot of the PRACH occasion in a system frame (0≤t_id<80). Subcarrier spacing (SCS) for determination of t_id is based on a value of μ. f_id is an index of the PRACH occasion in the frequency domain (0≤f_id<8). ul_carrier_id is a UL carrier used for the RA preamble transmission (0 for a normal uplink (NUL) carrier, 1 for a supplementary uplink (SUL) carrier). The RA-RNTI is calculated in accordance with a specification. The RA-RNTI is an RNTI for the 4-step RACH.

The MSGB-RNTI associated with a PRACH occasion in which the RA preamble is transmitted is calculated as follows.

$$MSGB - RNTI = 1 + s\_id + 14 \times t\_id + 14 \times 80 \times f\_id + 14 \times 80 \times 8 \times ul\_carrier \_id + 14 \times 80 \times 8 \times 2$$

Here, s_id is an index of the first OFDM symbol of the PRACH occasion (0≤s_id<14). t_id is an index of the first slot of the PRACH occasion in a system frame (0≤t_id<80). Subcarrier spacing (SCS) for determination of t_id is based on a value of p. f_id is an index of the PRACH occasion in the frequency domain (0≤f_id<8). ul_carrier_id is a UL carrier used for the RA preamble transmission (0 for a normal uplink (NUL) carrier, 1 for a supplementary uplink (SUL) carrier). The MSGB-RNTI is an RNTI for the 2-step RACH.

### (PDCCH Order)

### <DCI Format for PDCCH Order>

DCI format 1_0 includes a DCI format indicator field, a bit field always set to 1, and a frequency domain resource assignment field. When a cyclic redundancy check (CRC) of DCI format 1_0 is scrambled by a C-RNTI, and all the frequency domain resource assignment fields are 1, DCI format 1_0 is for random access procedure initiated by a PDCCH order, and the remaining fields are a random access preamble, a UL/supplementary Uplink (SUL) indicator, an SS/PBCH index (SSB index), a PRACH mask index, and a reserved bit (12 bits).

### <PRACH Occasion>

In a case of PRACH transmission triggered by the PDCCH order, when a value of a random access preamble index field is non-zero, a PRACH mask index field indicates a PRACH occasion for PRACH transmission for which a PRACH occasion is associated with an SS/PBCH block index indicated by an SS/PBCH block index field with the PDCCH order.

In a case of PRACH transmission triggered by a higher layer (PRACH transmission not triggered by the PDCCH order), if ssb-ResourceList is provided, the PRACH mask index is indicated by ra-ssb-OccasionMaskIndex. ra-ssb-OccasionMaskIndex indicates the PRACH occasion for PRACH transmission for which a PRACH occasion is associated with a selected SS/PBCH block index.

PRACH occasions are mapped consecutively for each corresponding SS/PBCH block index. Indexing of PRACH occasions indicated by mask index values is reset for each SS/PBCH block index or for each mapping cycle of consecutive PRACH occasions. In the first available mapping cycle, the UE selects, for the PRACH transmission, a PRACH occasion indicated by a PRACH mask index value for an indicated SS/PBCH block index.

For an indicated preamble index, the order of the PRACH occasions is as follows.
Firstly, order of increment of frequency resource indices for frequency-multiplexed PRACH occasions
Secondly, order of increment of time resource indices for time-multiplexed PRACH occasions in PRACH slot
Thirdly, ascending order of PRACH slot indices

If csirs-ResourceList is provided for PRACH transmission triggered in response to a request from the higher layer, a value of ra-OccasionList indicates a list of PRACH occasions for the PRACH transmission, and the PRACH occasions are associated with a selected CSI-RS index indicated by csi-RS. Indexing of PRACH occasions indicated by ra-OccasionList is reset for each association pattern period.

A value of the PRACH mask index value (msgA-SSB-SharedRO-MaskIndex) is associated with an allowed PRACH occasion for an SSB (PRACH occasion index value).

### <Random Access Procedure in MAC Entity>

The random access procedure is initiated by RRC for an event following a PDCCH order, a MAC entity itself, or a specification. In the MAC entity, only one ongoing random access procedure is present at an arbitrary timing. The random access procedure for an SCell is initiated only by a PDCCH order with ra-PreambleIndex different from 0b000000.

When the random access procedure is initiated on a serving cell, the MAC entity performs the following operation.
Set RA_TYPE to 4-stepRA when random access procedure is initiated by PDCCH order, and ra-PreambleIndex explicitly provided by PDCCH is not 0b000000 or when random access procedure is initiated for reconfiguration with synchronization, and contention-free random access resource of 4-step RA type is explicitly provided by rach-ConfigDedicated for BWP selected for random access procedure

When selected RA_TYPE is set to 4-stepRA, the MAC entity performs the following operation.
Set PREAMBLE_INDEX to notified ra-PreambleIndex and select SSB notified by PDCCH when ra-PreambleIndex is explicitly provided from PDCCH, and ra-PreambleIndex is not 0b000000
Determine next available PRACH occasion, based on PRACH occasions allowed by limitation given by ra-ssb-OccasionMaskIndex when SSB is selected in such a manner as that described above, the PRACH occasions corresponding to selected SSB (The MAC entity randomly selects, with equal probability, a PRACH occasion from consecutive PRACH occasions corresponding to the selected SSB, in accordance with a specification. The MAC entity may consider a possibility of occurrence of a measurement gap when determining the next available PRACH occasion corresponding to the selected SSB)

### <Time Between PDCCH Order Reception and PRACH Transmission>

If the random access procedure has been initiated by the PDCCH order, the UE transmits, if requested by the higher layer, a PRACH in the selected PRACH occasion in a case where time between the last symbol for PDCCH order reception and the first symbol for PRACH transmission is N_(T,2)+Δ_BWPSwitching+Δ_Delay+T_switch [msec] or greater (time condition), as described in a specification. Here, N_(T,2) is duration of an N_2 symbol corresponding to PUSCH preparation time for UE processing capability 1. Assume that p corresponds to minimum SCS configuration between subcarrier spacing (SCS) configuration for the PDCCH order and SCS configuration for PRACH transmission corresponding to the PDCCH order. Δ_BWPSwitching=0 when an active UL BWP does not vary, otherwise Δ_BWPSwitching is defined in the specification. In FR1, Δ_delay=0.5 msec, and in FR 2, Δ_delay=0.25 msec. T_switch is switching gap duration defined in the specification.

### <Condition for Validity/Invalidity of PRACH Occasion (Validity Condition)>

In a paired spectrum (FDD) or SUL band, all the PRACH occasions are valid. In an unpaired spectrum (TDD), the PRACH occasions may follow Requirements 1 and 2 below.

### {Requirement 1}

In a case where the UE is not provided with tdd-UL-DL-ConfigurationCommon, when a PRACH occasion in a PRACH slot starts after at least N_gap symbols from the last SS/PBCH block reception symbol without preceding an SS/PBCH block in the PRACH slot, the PRACH occasion is valid. Here, N_gap is defined in a specification. When channelAccessMode=semistatic is provided, the PRACH occasion does not overlap a set of consecutive symbols before a start of a subsequent channel occupancy time in which the UE does not perform transmission. An SS/PBCH block index of an SS/PBCH block candidate corresponds to an SS/PBCH block index provided by ssb-PositionsInBurst in SIB1 or in ServingCellConfigCommon.

### {Requirement 2}

When the UE is provided with tdd-UL-DL-ConfigurationCommon, the PRACH occasion in the PRACH slot is valid in the following case.
The PRACH occasion is present in a UL symbol. Alternatively,
The PRACH occasion starts after at least N_gap symbols from the last DL symbol and after at least N_gap symbols from the last SS/PBCH block symbol without preceding SS/PBCH block in a PRACH slot. Here, N_gap is defined in a specification. If channelAccessMode=semistatic is provided, the PRACH occasion, as described in the specification, does not overlap a set of consecutive symbols before a start of a subsequent channel occupancy time in which any transmission is not allowed. The SS/PBCH block index of the SS/PBCH block candidate, as described in the specification, corresponds to an SS/PBCH block index provided by ssb-PositionsInBurst in SIB1 or in ServingCellConfigCommon.

### (RAR Reception)

In response to PRACH transmission, the UE attempts to detect, in a window controlled by the above-described higher layer, DCI format 1_0 with a CRC scrambled by a corresponding RA-RNTI. The window starts in the first symbol of the earliest CORESET in which the UE is configured with reception of a PDCCH for a type 1-PDCCH CSS set, that is, at least 1 symbol after the last symbol of a PRACH occasion corresponding to the PRACH transmission. The symbol period corresponds to SCS for the type 1-PDCCH CSS set. A length of the window is provided as the number of slots by ra-responseWindow, based on the SCS for the type 1-PDCCH CSS set.

If the UE has detected DCI format 1_0 with the CRC scrambled by the corresponding RA-RNTI and the same least significant bits (LSBs) of an SFN field in a DCI format as LSBs of a system frame number (SFN) in which the UE has transmitted a PRACH, and the UE has received a transport block in a corresponding PDSCH, the UE may assume the same DMRS antenna port QCL properties in relation to an SS/PBCH block or a CSI-RS resource used by the UE for association of the PRACH, irrespective of whether the UE is provided with a TCI state (TCI-State) for a CORESET for receiving a PDCCH with DCI format 1_0.

If the UE attempts to detect, in response to PRACH transmission initiated by a PDCCH order for triggering CFRA procedure for an SpCell, DCI format 1_0 with a CRC scrambled by a corresponding RA-RNTI, the UE may assume that a PDCCH including DCI format 1_0 and the PDCCH order have the same DMRS antenna port QCL properties. If the UE attempts to detect, in response to PRACH transmission initiated by a PDCCH order for triggering CFRA procedure for a secondary cell, DCI format 1_0 with a CRC scrambled by a corresponding RA-RNTI, the UE may assume DMRS antenna port QCL properties of a CORESET associated with a type 1-PDCCH CSS set for reception of a PDCCH including DCI format 1_0.

The RAR UL grant may include at least one of a frequency hopping flag field, a PUSCH frequency resource allocation field, a PUSCH time resource allocation field, a modulation and coding scheme (MCS) field, a TPC command field for PUSCH, a CSI request field, and a channel access-cyclic prefix extension (CPext) field.

### (Uplink Coverage Improvement for PRACH)

The following two cases/types of multi-PRACH transmission are under study.

### {Case 1/Type 1 Multi-PRACH Transmission}

The UE performs repetition transmission of Msg1 on n random access occasions (ROs)/RO resources. Subsequently, the UE waits for detection of Msg2 in a configured type 1 PDCCH occasion. In the present disclosure, preamble repetition transmission in n ROs/RO resources is sometimes referred to as an RO group. A size of the RO group (the number of ROs in the RO group) is n. One RAR window is started after one RO group.

### {Case 2/Type 2 Multi-PRACH Transmission}

The UE performs repetition transmission of Msg1 on n random access occasion (RO) resources. After transmission of Msg1 on each RO, the UE waits for detection of Msg2 in a type 1 PDCCH occasion. A size of the RO group (the number of ROs in the RO group) is n. One RAR window is started after each RO.

### (Beam Used for PRACH Repetitions)

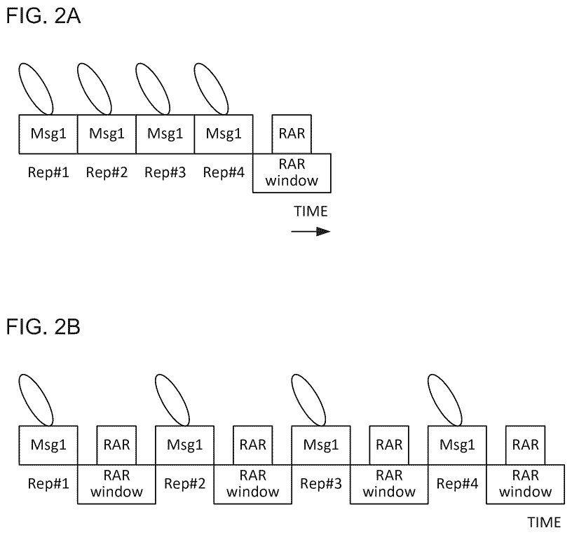

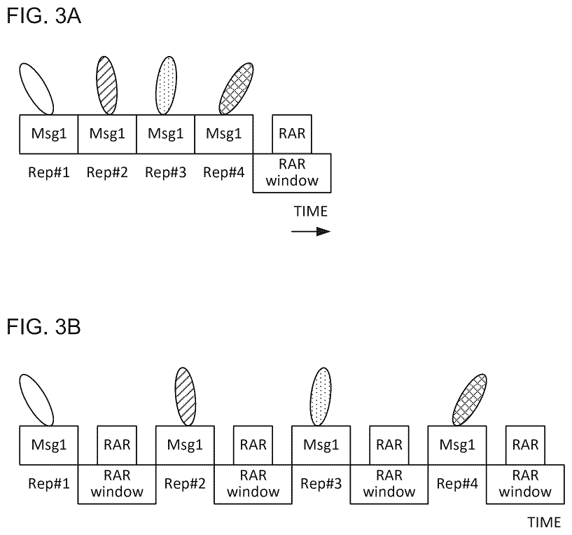

For Rel. 18, it is studied that a function for PRACH repetitions with the using the same beam and a function for PRACH repetitions with a plurality of different beams are introduced. FIG. 2A shows an example of a case where one RAR window is used for a plurality of PRACH repetitions using the using the same beam (type 1 multi-PRACH transmission). FIG. 2B shows an example of a case where a plurality of RAR windows are used for a plurality of respective PRACH repetitions using the same beam (type 2 multi-PRACH transmission). FIG. 3A shows an example of a case where one PAR window is used for a plurality of PRACH repetitions using a plurality of different beams (type 1 multi-PRACH transmission). FIG. 3B shows an example of a case where a plurality of RAR windows are used for a plurality of respective PRACH repetitions using a plurality of different beams (type 2 multi-PRACH transmission).

However, the relationship/combination/interaction between the two functions remains unclear. For example, it remains unclear whether of the two functions can be simultaneously supported/employed. If of the two functions are not simultaneously supported/employed, it remains unclear how the UE determines whether to transmit PRACH repetitions by using the same beam, transmit PRACH repetitions by using a plurality of different beams, or drop PRACH repetitions. If of the two functions are simultaneously supported/employed, it remains unclear when the UE simultaneously employs the two functions. Thus, unless the relationship between the two functions is made clear, degradation in communication quality and the like may occur.

Thus, the inventors of the present invention came up with the idea of a relationship between a function for PRACH repetitions with the same beam and a function for PRACH repetitions with a plurality of different beams.

Embodiments according to the present disclosure will be described in detail with reference to the drawings as follows.

The radio communication methods according to respective embodiments may each be employed individually, or may be employed in combination.

In the present disclosure, “A/B” and “at least one of A and B” may be interchangeably interpreted. In the present disclosure, “A/B/C” may mean “at least one of A, B, and C.”

In the present disclosure, notify, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, a field, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

Note that, in the present disclosure, “have a capability for . . . ” and “support/report a capability for . . . ” may be interchangeably interpreted.

### (Radio Communication Method)

In each embodiment, one RACH attempt, procedure for PRACH repetitions to judgment of RAR reception, and PRACH repetitions of the number of repetitions may be interchangeably interpreted. One RACH attempt may be ended in response to success or failure in reception of a corresponding RAR. In response to failure in reception of an BAR in one RACH attempt, another RACH attempt may be started.

In each embodiment, a PRACH (first transmission scheme) without repetitions may be a PRACH for which repetitions are applied/determined/configured/indicated. In each embodiment, PRACH repetitions using the same beam (second transmission scheme) may be use of one same beam/TCI state/spatial domain filter for a plurality of PRACH repetitions. In each embodiment, PRACH repetitions using a plurality of different beams (third transmission scheme) may be use of a plurality of different beams/TCI states/spatial domain filters for a plurality of respective PRACH repetitions. In each embodiment, PRACH repetitions using the same beam and a plurality of different beams (fourth transmission scheme) may be a case that a plurality of PRACH repetitions include a plurality of sets of repetitions, each set includes two or more repetitions, the same beam/TCI state/spatial domain filter is used for two or more repetitions in each set, and a plurality of different beams/TCI states/spatial domain filters are used for the plurality of respective sets.

In each embodiment, a function for PRACH repetitions using the same beam and a function for PRACH repetitions using a plurality of different beams, two functions, two transmission methods, two transmission schemes, and two repetition schemes may be interchangeably interpreted.

In each embodiment, a function for a PRACH without repetitions, a function for PRACH repetitions using the same beam, and a function for PRACH repetitions using a plurality of different beams, three functions, three transmission methods, and three transmission schemes may be interchangeably interpreted.

In each embodiment, a function for a PRACH without repetitions, a function for PRACH repetitions using the same beam, a function for PRACH repetitions using a plurality of different beams, and a function for PRACH repetitions using the same beam and a plurality of different beams, four functions, four transmission methods, and four transmission schemes may be interchangeably interpreted.

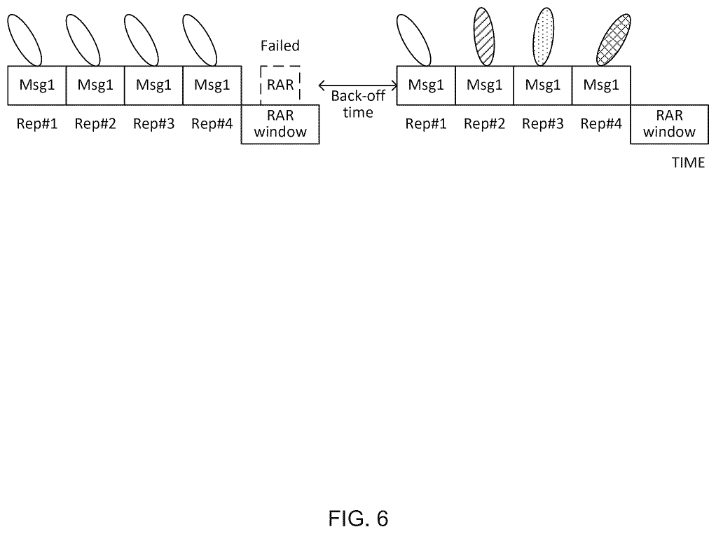

The operation in each diagram of each embodiment (for example, each of FIGS. 6 to 11) is applied to a case where one RAR window is used after a plurality of PRACH repetitions (type 1 multi-PRACH transmission), but may be applied to a case where one RAR window is used after each PRACH repetition (type 2 multi-PRACH transmission).

A UE may determine one transmission scheme from among a first transmission scheme for transmitting a physical random access channel (PRACH) without a plurality of repetitions, a second transmission scheme for transmitting the plurality of repetitions by using the same beam, a third transmission scheme for transmitting the plurality of repetitions by using a plurality of different beams, and a fourth transmission scheme for transmitting the plurality of repetitions by using the same beam and a plurality of different beams. The UE may transmit one or more PRACHs by using the transmission scheme.

### Embodiment #1

This embodiment relates to whether PRACH repetitions using the same beam and PRACH repetitions using a plurality of different beams are simultaneously applied.

### <<Option 1>>

“The UE does not assume simultaneous reporting of a capability for PRACH repetitions using the same beam and a capability for PRACH repetitions using a plurality of different beams” may be defined.

### <<Option 2>>

“The UE does not assume that simultaneous enabling/configuration of PRACH repetitions using the same beam and PRACH repetitions using a plurality of different beams is indicated/configured by a base station” may be defined.

“The UE does not assume that PRACH repetitions using the same beam and PRACH repetitions using a plurality of different beams are simultaneously enabled/configured by an SIB/RRC IE” may be defined. “The UE does not assume that any RACH resource set configured with indication for PRACH repetitions using the same beam and any RACH resource set configured with indication for PRACH repetitions using a plurality of different beams are present” may be defined. “The UE does not assume that any RACH resource set configured for PRACH repetitions using the same beam and any RACH resource set configured for PRACH repetitions using a plurality of different beams are present” may be defined.

### <<Option 3>>

“The UE does not assume that the two functions are simultaneously employed in one RACH attempt” may be defined.

“When transmitting PRACH repetitions on a plurality of different beams in one RACH attempt, the UE does not assume transmission of a plurality of PRACH repetitions using the same beam” may be defined. “When transmitting PRACH repetitions on a plurality of different beams in one RACH attempt, the UE does not assume transmission of a PRACH occasion on any RACH resource set configured for PRACH repetitions using the same beam” may be defined. “In one RACH attempt, the UE does not assume that any RACH resource set configured for both PRACH repetitions using the same beam and PRACH repetitions using a plurality of different beams is present” may be defined.

### <<Option 4>>

The two functions may be simultaneously employed for the UE in one RACH attempt.

### <<Option 5>>

“The UE does not assume that the two functions are simultaneously employed in one RACH attempt” may be defined. Option 5 may, based on Option 3, be accompanied by an additional requirement that the UE does not assume transmission of a plurality of PRACH repetitions using the same beam in one RACH attempt in one RACH procedure, and transmission of a plurality of PRACH repetitions using a plurality of different beams in another RACH attempt in the RACH procedure (before expiration of a preamble transmission counter “PREAMBLE_TRANSMISSION_COUNTER”).

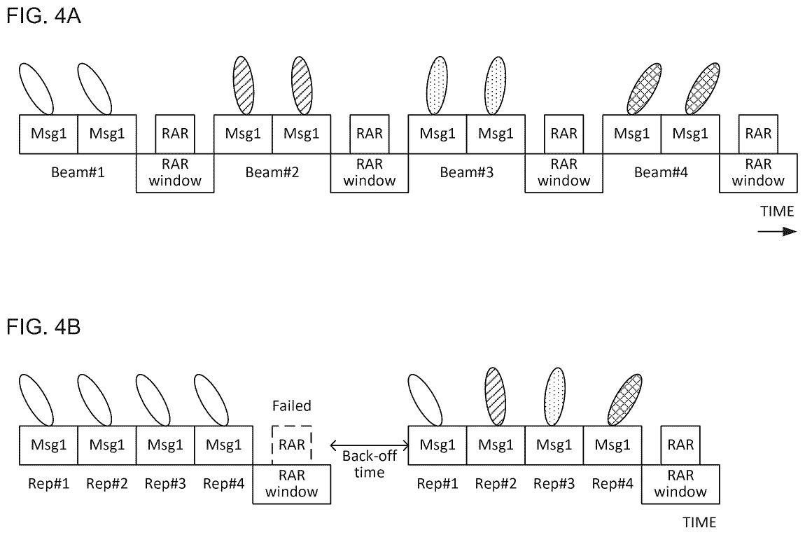

In an example in FIG. 4A, the UE transmits a plurality of repetitions of a PRACH (Msg1) using the same beam and a plurality of different beams in one RACH attempt. One beam and one RAR window are used for two repetitions of the PRACH. A plurality of PAR windows correspond to a plurality of respective different beams. This example is not allowed for Option 3/5. This example is allowed for Option 4.

In an example in FIG. 4B, the UE transmits a plurality of PRACH repetitions using the same beam in one RACH attempt in one RACH procedure, and transmits, when failing to receive an RAR, a plurality of PRACH repetitions using a plurality of different beams in another RACH attempt in the same RACH procedure. One RAR window is used for one RACH attempt. This example is not allowed for Option 5. This example is allowed for Option 3.

The UE may support at least one of the following some cases.

{Case 1}A case where the UE reports only the capability for PRACH repetitions using the same beam, from among the two functions, and where only the PRACH repetitions using the same beam is enabled/configured by the base station.

The UE determines whether to transmit a PRACH without repetitions or PRACH repetitions using the same beam.

{Case 2}A case where the UE reports only the capability for PRACH repetitions using a plurality of different beams, from among the two functions, and where only the PRACH repetitions using the same beam is enabled/configured by the base station.

The UE transmits a PRACH without repetitions.

{Case 3}A case where the UE reports the capability for PRACH repetitions using the same beam and the capability for PRACH repetitions using a plurality of different beams and where only the PRACH repetitions using the same beam is enabled/configured by the base station.

In Option 1, this case is an error case. In Option 2/3/4/5, the UE determines whether to transmit a PRACH without repetitions or PRACH repetitions using the same beam.

{Case 4}A case where the UE reports only the capability for PRACH repetitions using the same beam, from among the two functions, and where only the PRACH repetitions using a plurality of different beams is enabled/configured by the base station.

The UE transmits a PRACH without repetitions.

{Case 5}A case where the UE reports only the capability for PRACH repetitions using a plurality of different beams, from among the two functions, and where only the PRACH repetitions using a plurality of different beams is enabled/configured by the base station.

The UE determines whether to transmit a PRACH without repetitions or PRACH repetitions using a plurality of different beams.

{Case 6}A case where the UE reports the capability for PRACH repetitions using the same beam and the capability for PRACH repetitions using a plurality of different beams and where only the PRACH repetitions using a plurality of different beams is enabled/configured by the base station.

In Option 1, this case is an error case. In Option 2/3/4/5, the UE determines whether to transmit a PRACH without repetitions or PRACH repetitions using a plurality of different beams.

{Case 7}A case where the UE reports only the capability for PRACH repetitions using the same beam, from among the two functions, and where the PRACH repetitions using the same beam and the PRACH repetitions using a plurality of different beams are simultaneously enabled/configured by the base station.

In Option 1/3/4/5, the UE determines whether to transmit a PRACH without repetitions or PRACH repetitions using the same beam. In Option 2, this case is an error case.

{Case 8}A case where the UE reports only the capability for PRACH repetitions using a plurality of different beams, from among the two functions, and where the PRACH repetitions using the same beam and the PRACH repetitions using a plurality of different beams are simultaneously enabled/configured by the base station.

In Option 1/3/4/5, the UE determines whether to transmit a PRACH without repetitions or PRACH repetitions using a plurality of different beams. In Option 2, this case is an error case.

{Case 9}A case where the UE reports the capability for PRACH repetitions using the same beam and the capability for PRACH repetitions using a plurality of different beams and where the PRACH repetitions using the same beam and the PRACH repetitions using a plurality of different beams are simultaneously enabled/configured by the base station.

In Option 1/2, this case is an error case. In Option 3, the UE determines which of a PRACH without repetitions, PRACH repetitions using the same beam, or PRACH repetitions using a plurality of different beams is to be applied. In Option 4, the UE determines which of a PRACH without repetitions, PRACH repetitions using the same beam, PRACH repetitions using a plurality of different beams, or PRACH repetitions using the same beam and a plurality of different beams is to be applied. In Option 5, the UE may follow, for each RACH attempt, at least one of the following some operations.
If the RACH attempt is the first RACH attempt in RACH procedure or if the UE has not transmitted a PRACH with repetitions in any previous RACH attempt in the RACH procedure, the UE determines which of a PRACH without repetitions, PRACH repetitions using the same beam, or PRACH repetitions using a plurality of different beams is to be applied.
If the UE has transmitted a plurality of PRACH repetitions using the same beam in any previous RACH attempt in the RACH procedure, the UE determines which of a PRACH without repetitions or PRACH repetitions using the same beam is to be applied.
If the UE has transmitted a plurality of PRACH repetitions using a plurality of different beams in any previous RACH attempt in the RACH procedure, the UE determines which of a PRACH without repetitions or PRACH repetitions using a plurality of different beams is to be applied.

The UE may determine, based on at least one of the following some elements, at least one of whether to perform PRACH repetitions and whether to use the same beam, a plurality of different beams, or the same beam and a plurality of different beams for PRACH repetitions.
Definition in specification
Indication by SIB/RRC IE/PDCCH order
RO configuration parameter
Current PREAMBLE_TRANSMISSION_COUNTER
Random access limit parameter; for example, at least one of preambleTransMax, ra-ResponseWindow, and ra-ContentionResolutionTimer.
RSRP for one or more receptions of SSB(s) or CSI-RS(s)
Priority for PRACH repetitions using same beam and PRACH repetitions using plurality of different beams
UE capability related to beam correspondence

The UE may determine whether to perform a plurality of PRACH repetitions and whether to use the same beam, a plurality of different beams, or the same beam and a plurality of different beams for PRACH repetitions, based on at least one of a deployment scenario, a duplex mode, a frequency range, and whether a band is a licensed or an unlicensed band. The deployment scenario may be, for example, a terrestrial network or a non-terrestrial network, or may be a type of a non-terrestrial network. The duplex mode may be, for example, TDD (unpaired spectrum) or FDD (paired spectrum). The frequency range may be, for example, FR1/2-1/2-2. Whether a band is a licensed band or an unlicensed band, whether a cell is a licensed cell or an unlicensed cell, whether a spectrum is a shared spectrum, and whether shared spectrum channel access is used may be interchangeably interpreted.

For example, the UE may transmit, in a geostationary orbit (Geostationary Earth Orbit, GEO) scenario, a plurality of PRACH repetitions using the same beam/a plurality of different beams, and may transmit, in a low orbit (Low Earth Orbit, LEO) scenario, a PRACH without repetitions. For example, the UE may transmit, in a TDD (unpaired spectrum), a plurality of PRACH repetitions using the same beam/a plurality of different beams, and may transmit, in an FDD (paired spectrum), a PRACH without repetitions. For example, the UE may transmit, in a licensed band, a plurality of PRACH repetitions using the same beam/a plurality of different beams, and may transmit, in an unlicensed band, a PRACH without repetitions. For example, the UE may transmit, in FR2-2, a plurality of PRACH repetitions using the same beam/a plurality of different beams, and may transmit, in FR1/2-1, a PRACH without repetitions.

### Example 1

This example relates to how the UE determines a transmission method/transmission scheme for whether to transmit a PRACH without repetitions or PRACH repetitions using the same beam (and the number of repetitions). This example may correspond to Case 1/3/7.

### {Choice 1-0}

The transmission method may be defined by a specification. The specification may define that the UE always transmits PRACH repetitions using the same beam or the UE always transmits a PRACH without repetitions. The specification may define different operations for different cases (from among Cases 1/3/7).

### {Choice 1-1}

The transmission method may be indicated by an SIB/RRC IE/PDCCH order (for PDCCH ordered RACH procedure). The base station may indicate, by using the SIB/RRC IE/PDCCH order, whether PRACH repetitions using the same beam are performed (and the number of repetitions).

### {Choice 1-2}

The transmission method may be based on a RACH triggering method/RACH purpose. The RACH triggering method may be a method in which a RACH is started by a PDCCH order/MAC entity/RRC. The RACH purpose may be initial access/system information (SI) request/SpCell BFR/reconfiguration with synchronization (reconfiguration with sync).

Relationship/mapping between whether to transmit PRACH repetitions using the same beam (and the number of repetitions) and the RACH triggering method/RACH purpose may be defined by a specification or may be configured by an SIB/RRC IE.

### {Choice 1-3}

The transmission method may be based on an RO configuration parameter. The RO configuration parameter may be at least one of a PRACH configuration index, a PRACH format, the number of SSBs per RO, the number of PRACH transmission occasions FDMed in one time instance, the number of PRACH slots in one subframe, the number of time domain PRACH occasions in one PRACH slot, PRACH duration, zeroCorrelationZoneConfig (configuration of the number of cyclic shifts), and a total number of preambles (for PRACH repetitions using the same beam).

Relationship/mapping between whether to transmit PRACH repetitions using the same beam (and the number of repetitions) and the RO configuration parameter may be defined by a specification or may be configured by an SIB/RRC IE.

### {Choice 1-4}

The transmission method may be based on PREAMBLE_TRANSMISSION_COUNTER. If PREAMBLE_TRANSMISSION_COUNTER is greater than a given value (defined by a specification or indicated by an SIB/RRC IE), the UE may transmit PRACH repetitions using the same beam. Otherwise, the UE may transmit a PRACH without repetitions.

The number of PRACH repetitions may be based on PREAMBLE_TRANSMISSION_COUNTER. For example, for PREAMBLE_TRANSMISSION_COUNTER less than M1, the number of PRACH repetitions may be N1. For PREAMBLE_TRANSMISSION_COUNTER greater than or equal to M1 and less than M2, the number of PRACH repetitions may be N2. For PREAMBLE_TRANSMISSION_COUNTER greater than or equal to M2, the number of PRACH repetitions may be N3.

### {Choice 1-5}

The transmission method may be based on a value configured for a random access limit parameter (at least one of preambleTransMax, ra-ResponseWindow, and ra-ContentionResolutionTimer). In at least one of a case where a value configured for preambleTransMax is less than/greater than/equal to a given value Y1, a case where a value configured for ra-ResponseWindow is less than/greater than/equal to a given value Y2, and a case where a value configured for ra-ContentionResolutionTimer is less than/greater than/equal to a given value Y3, the UE may transmit PRACH repetitions using the same beam. Otherwise, the UE may transmit a PRACH without repetitions. Here, Y1, Y2, and Y3 may be defined by a specification or may be indicated by an SIB/RRC IE.

The number of PRACH repetitions may or may not depend on the random access limit parameter.

### {Choice 1-6}

The transmission method may be based on RSRP for one or more receptions of SSB(s) or CSI-RS(s).

The UE may determine whether to transmit PRACH repetitions using the same beam (and the number of repetitions), based on at least one of an RSRP value of an SSB/CSI-RS selected (in accordance with a rule in Rel. 15/16/17) and a range of values of an RSRP gap. The gap may be a gap between RSRP of the selected SSB/CSI-RS and the highest RSRP value among all the RSRP values or an averaged RSRP value of all the RSRP values (or an RSRP value exceeding rsrp-ThresholdSSB, from among the top N highest RSRP values). Whether to drop PRACH repetitions or perform PRACH repetitions using the same beam (and the number of repetitions) may correspond to a range of values of the gap. Relationship/mapping of the correspondence may be defined by a specification or may be indicated by an SIB/RRC IE. For example, the mapping may associate whether PRACH repetitions using the same beam are transmitted (and the number of repetitions) with the gap greater/less than a given value.

The UE may transmit PRACH repetitions using the same beam in at least one of a case where RSRP for reception of the selected SSB/CSI-RS is less than a given value, a case where RSRP for reception of the selected SSB/CSI-RS is not (one of) the top (N) highest RSRP values among all the RSRP values, and a case where RSRP for reception of the selected SSB/CSI-RS is at least M dB less than the highest RSRP value or the averaged RSRP value. Otherwise, the UE may transmit a PRACH without repetitions. Here, the given value, N, and M are integers, and may be defined by a specification or may be indicated by an SIB/RRC IE.

The UE may determine whether to transmit PRACH repetitions using the same beam (and the number of repetitions), based on all the RSRP values (or RSRP values exceeding rsrp-ThresholdSSB or the top N highest RSRP values), based on a highest value/lowest value/average value/standard deviation of all the RSRP values (or RSRP values exceeding rsrp-ThresholdSSB or the top N highest RSRP values), or based on the number of RSRP values in a given range. Whether to perform a PRACH without repetitions or PRACH repetitions using the same beam (and the number of repetitions) may correspond to at least one of a plurality of different ranges for a highest value/lowest value/average value/standard deviation of all the RSRP values (or RSRP values exceeding rsrp-ThresholdSSB or the top N highest RSRP values) and a plurality of different ranges for the number of RSRP values in a given range. Relationship/mapping of the correspondence may be defined by a specification or may be indicated by an SIB/RRC IE. For example, the mapping may associate whether PRACH repetitions using the same beam are transmitted (and the number of repetitions) with the RSRP based value greater/less than a given value.

A combination of at least two of Choices 1-1 to 1-6 may be used.

### Example 2

This example relates to how the UE determines a transmission method/transmission scheme for whether to transmit a PRACH without repetitions or PRACH repetitions using a plurality of different beams. This example may correspond to Case 5/6/8.

### {Choice 2-0}

The transmission method may be defined by a specification. The specification may define that the UE always transmits PRACH repetitions using a plurality of different beams or the UE always transmits a PRACH without repetitions. The specification may define different operations for different cases (from among Cases 5/6/8).

### {Choice 2-1}

The transmission method may be indicated by an SIB/RRC IE/PDCCH order (for PDCCH ordered RACH procedure). The base station may indicate, by using the SIB/RRC IE/PDCCH order, whether PRACH repetitions using a plurality of different beams are performed (and the number of repetitions/number of beams).

### {Choice 2-2}

The transmission method may be based on a RACH triggering method/RACH purpose. The RACH triggering method may be a method in which a RACH is started by a PDCCH order/MAC entity/RRC. The RACH purpose may be initial access/system information (SI) request/SpCell BFR/reconfiguration with synchronization (reconfiguration with sync).

Relationship/mapping between whether to transmit PRACH repetitions using a plurality of different beams (and the number of repetitions/number of beams or a plurality of beams for a plurality of repetitions) and the RACH triggering method/RACH purpose may be defined by a specification or may be configured by an SIB/RRC IE.

### {Choice 2-3}

The transmission method may be based on an RO configuration parameter. The RO configuration parameter may be at least one of a PRACH configuration index, a PRACH format, the number of SSBs per RO, the number of PRACH transmission occasions FDMed in one time instance, the number of PRACH slots in one subframe, the number of time domain PRACH occasions in one PRACH slot, PRACH duration, zeroCorrelationZoneConfig (configuration of the number of cyclic shifts), and a total number of preambles (for PRACH repetitions using a plurality of different beams).

Relationship/mapping between whether to transmit PRACH repetitions using a plurality of different beams (and the number of repetitions/number of beams) and the RO configuration parameter may be defined by a specification or may be configured by an SIB/RRC IE.

### {Choice 2-4}

The transmission method may be based on PREAMBLE_TRANSMISSION_COUNTER. If PREAMBLE_TRANSMISSION_COUNTER is greater than a given value (defined by a specification or indicated by an SIB/RRC IE), the UE may transmit PRACH repetitions using a plurality of different beams. Otherwise, the UE may transmit a PRACH without repetitions.

The number of PRACH repetitions/number of beams may be based on PREAMBLE_TRANSMISSION_COUNTER. For example, for PREAMBLE_TRANSMISSION_COUNTER less than M1, the number of PRACH repetitions/number of beams may be N1. For PREAMBLE_TRANSMISSION_COUNTER greater than or equal to M1 and less than M2, the number of PRACH repetitions/number of beams may be N2. For PREAMBLE_TRANSMISSION_COUNTER greater than or equal to M2, the number of PRACH repetitions/number of beams may be N3.

### {Choice 2-5}

The transmission method may be based on a value configured for a random access limit parameter (at least one of preambleTransMax, ra-ResponseWindow, and ra-ContentionResolutionTimer). In at least one of a case where a value configured for preambleTransMax is less than/greater than/equal to a given value Y1, a case where a value configured for ra-ResponseWindow is less than/greater than/equal to a given value Y2, and a case where a value configured for ra-ContentionResolutionTimer is less than/greater than/equal to a given value Y3, the UE may transmit PRACH repetitions using a plurality of different beams. Otherwise, the UE may transmit a PRACH without repetitions. Here, Y1, Y2, and Y3 may be defined by a specification or may be indicated by an SIB/RRC IE.

The number of PRACH repetitions/number of beams may or may not depend on the random access limit parameter.

### {Choice 2-6}

The transmission method may be based on RSRP for one or more receptions of SSB(s) or CSI-RS(s).

The UE may determine whether to transmit PRACH repetitions using a plurality of different beams (and the number of repetitions/number of beams), based on at least one of an RSRP value of an SSB/CSI-RS selected (in accordance with a rule in Rel. 15/16/17) and a range of values of an RSRP gap. The gap may be a gap between RSRP of the selected SSB/CSI-RS and the highest RSRP value among all the RSRP values or an averaged RSRP value of all the RSRP values (or an RSRP value exceeding rsrp-ThresholdSSB, from among the top N highest RSRP values). Whether to drop PRACH repetitions or perform PRACH repetitions using a plurality of different beams (and the number of repetitions/number of beams) may correspond to a range of values of the gap.

Relationship/mapping of the correspondence may be defined by a specification or may be indicated by an SIB/RRC IE. For example, the mapping may associate whether PRACH repetitions using a plurality of different beams are transmitted (and the number of repetitions/number of beams) with the gap greater/less than a given value.

The UE may transmit PRACH repetitions using a plurality of different beams in at least one of a case where RSRP for reception of the selected SSB/CSI-RS is less than a given value, a case where RSRP for reception of the selected SSB/CSI-RS is not (one of) the top (N) highest RSRP values among all the RSRP values, and a case where RSRP for reception of the selected SSB/CSI-RS is at least M dB less than the highest RSRP value or the averaged RSRP value. Otherwise, the UE may transmit a PRACH without repetitions. Here, the given value, N, and M are integers, and may be defined by a specification or may be indicated by an SIB/RRC IE.

The UE may determine whether to transmit PRACH repetitions using a plurality of different beams (and the number of repetitions/number of beams), based on all the RSRP values (or RSRP values exceeding rsrp-ThresholdSSB or the top N highest RSRP values), based on a highest value/lowest value/average value/standard deviation of all the RSRP values (or RSRP values exceeding rsrp-ThresholdSSB or the top N highest RSRP values), or based on the number of RSRP values in a given range. Whether to perform a PRACH without repetitions or PRACH repetitions using a plurality of different beams (and the number of repetitions/number of beams) may correspond to at least one of a plurality of different ranges for a highest value/lowest value/average value/standard deviation of all the RSRP values (or RSRP values exceeding rsrp-ThresholdSSB or the top N highest RSRP values) and a plurality of different ranges for the number of RSRP values in a given range. Relationship/mapping of the correspondence may be defined by a specification or may be indicated by an SIB/RRC IE. For example, the mapping may associate whether PRACH repetitions using a plurality of different beams are transmitted (and the number of repetitions/number of beams) with the RSRP based value greater/less than a given value.

### {Choice 2-7}

The transmission method may be based on a UE capability for beam correspondence. If the UE does not have/report the capability for beam correspondence, the UE may transmit PRACH repetitions using a plurality of different beams. If the UE has/reports the capability for beam correspondence, the UE may transmit a PRACH without repetitions.

A combination of at least two of Choices 2-1 to 2-7 may be used.

### Example 3

This example relates to how the UE determines a transmission method/transmission scheme for whether to transmit a PRACH without repetitions, PRACH repetitions using the same beam, or PRACH repetitions using a plurality of different beams (one transmission method from among the three transmission methods). This example may correspond to Case 9.

### {Choice 3-0}

The transmission method may be defined by a specification. The specification may define that the UE always transmits PRACH repetitions using the same beam, the UE always transmits PRACH repetitions using a plurality of different beams (and the number of beams), or the UE always transmits a PRACH without repetitions.

### {Choice 3-1}

The transmission method may be indicated by an SIB/RRC IE/PDCCH order (for PDCCH ordered RACH procedure). The base station may indicate, by using the SIB/RRC IE/PDCCH order, one transmission method from among the three transmission methods (and the number of repetitions/number of beams in a case of a plurality of PRACH repetitions).

### {Choice 3-2}

The transmission method may be based on a RACH triggering method/RACH purpose. The RACH triggering method may be a method in which a RACH is started by a PDCCH order/MAC entity/RRC. The RACH purpose may be initial access/system information (SI) request/SpCell BFR/reconfiguration with synchronization (reconfiguration with sync).

Relationship/mapping between whether to transmit a PRACH without repetitions, PRACH repetitions using the same beam (and the number of repetitions), or PRACH repetitions using a plurality of different beams (and the number of repetitions/number of beams) and the RACH triggering method/RACH purpose may be defined by a specification or may be configured by an SIB/RRC IE.

### {Choice 3-3}

The transmission method may be based on an RO configuration parameter. The RO configuration parameter may be at least one of a PRACH configuration index, a PRACH format, the number of SSBs per RO, the number of PRACH transmission occasions FDMed in one time instance, the number of PRACH slots in one subframe, the number of time domain PRACH occasions in one PRACH slot, PRACH duration, zeroCorrelationZoneConfig (configuration of the number of cyclic shifts), and a total number of preambles (for PRACH repetitions using the same beam/plurality of different beams).

Relationship/mapping between whether to transmit a PRACH without repetitions, PRACH repetitions using the same beam (and the number of repetitions), or PRACH repetitions using a plurality of different beams (and the number of repetitions/number of beams) and the RO configuration parameter may be defined by a specification or may be configured by an SIB/RRC IE.

### {Choice 3-4}

The transmission method may be based on PREAMBLE_TRANSMISSION_COUNTER.

Whether to transmit a PRACH without repetitions, PRACH repetitions using the same beam (and the number of repetitions), or PRACH repetitions using a plurality of different beams (and the number of repetitions/number of beams) may correspond to different ranges of values of PREAMBLE_TRANSMISSION_COUNTER. Relationship/mapping between the three transmission methods and the range may be defined by a specification or may be configured by an SIB/RRC IE. For example, the mapping may associate one transmission method from among the three transmission methods with the RSRP based value greater/less than a given value.

When PREAMBLE_TRANSMISSION_COUNTER is greater than or equal to X0/less than X1, the UE may transmit a PRACH without repetitions. When PREAMBLE_TRANSMISSION_COUNTER is greater than or equal to X2/less than X3, the UE may transmit PRACH repetitions using the same beam. The number of PRACH repetitions may be determined based on PREAMBLE_TRANSMISSION_COUNTER. For example, when Y0<(or ≤) PREAMBLE_TRANSMISSION_COUNTER <(or ≤) Y1, the number of PRACH repetitions may be N1. When PREAMBLE_TRANSMISSION_COUNTER is greater than or equal to X4/less than X5, the UE may transmit PRACH repetitions using a plurality of different beams. The number of PRACH repetitions/number of beams may be determined based on PREAMBLE_TRANSMISSION_COUNTER. For example, when Y2<(or ≤) PREAMBLE_TRANSMISSION_COUNTER <(or ≤) Y3, the number of PRACH repetitions/number of beams may be N2.

### {Choice 3-5}

The transmission method may be based on a value configured for a random access limit parameter (at least one of preambleTransMax, ra-ResponseWindow, and ra-ContentionResolutionTimer).

Whether to transmit a PRACH without repetitions, PRACH repetitions using the same beam (and the number of repetitions), or PRACH repetitions using a plurality of different beams (and the number of repetitions/number of beams) may correspond to different ranges of values of the random access limit parameter. Relationship/mapping between the three transmission methods and the range may be defined by a specification or may be configured by an SIB/RRC IE. For example, the mapping may associate one transmission method from among the three transmission methods with the RSRP based value greater/less than a given value.

The UE may transmit a PRACH without repetitions in at least one of a case where preambleTransMax is greater than or equal to X0/less than X1, a case where ra-ResponseWindow is greater than or equal to Y0/less than Y1, and a case where ra-ContentionResolutionTimer is greater than or equal to Z0/less than Z1. The UE may transmit PRACH repetitions using the same beam in at least one of a case where preambleTransMax is greater than or equal to X2/less than X3, a case where ra-ResponseWindow is greater than or equal to Y2/less than Y3, and a case where ra-ContentionResolutionTimer is greater than or equal to Z2/less than Z3. The UE may transmit PRACH repetitions using a plurality of different beams in at least one of a case where preambleTransMax is greater than or equal to X4/less than X5, a case where ra-ResponseWindow is greater than or equal to Y4/less than Y5, and a case where ra-ContentionResolutionTimer is greater than or equal to Z4/less than Z5.

The number of PRACH repetitions/number of beams may or may not depend on the random access limit parameter.

### {Choice 3-6}

The transmission method may be based on RSRP for one or more receptions of SSB(s) or CSI-RS(s).

The UE may determine one transmission method from among the three transmission methods (and the number of repetitions/number of beams in a case of a plurality of PRACH repetitions), based on at least one of an RSRP value of an SSB/CSI-RS selected (in accordance with a rule in Rel. 15/16/17), a range of values of an RSRP gap, all the RSRP values (or RSRP values exceeding rsrp-ThresholdSSB or the top N highest RSRP values), a highest value/lowest value/average value/standard deviation of all the RSRP values (or RSRP values exceeding rsrp-ThresholdSSB or the top N highest RSRP values), and the number of RSRP values in a given range. The gap may be a gap between RSRP of the selected SSB/CSI-RS and the highest RSRP value among all the RSRP values or an averaged RSRP value of all the RSRP values (or an RSRP value exceeding rsrp-ThresholdSSB, from among the top N highest RSRP values). At least one of the three transmission methods may correspond to a range of values of the gap. Relationship/mapping of the correspondence may be defined by a specification or may be indicated by an SIB/RRC IE. For example, the mapping may associate one transmission method from among the three transmission methods with the gap greater/less than a given value.

In at least one of a case where RSRP for reception of an SSB/CSI-RS selected (in accordance with a rule in Rel. 15/16/17) is within a given range, a case where the gap is within a given range, a case where all the RSRP values (or RSRP values exceeding rsrp-ThresholdSSB or the top N highest RSRP values) are within a given range, a case where a highest value/lowest value/average value/standard deviation of all the RSRP values (or RSRP values exceeding rsrp-ThresholdSSB or the top N highest RSRP values) is within a given range, a case where more/less than M RSRP values are within a given range, a case where a highest value/lowest value/average value/standard deviation of RSRP values for reception of all the SSBs/CSI-RSs is within a given range, and a case where a highest value/lowest value/average value/standard deviation of RSRP values exceeding rsrp-ThresholdSSB is within a given range, the UE may transmit PRACH repetitions using a plurality of different beams if an RSRP value for reception of the selected SSB/CSI-RS is not (one of) the highest (top X highest) RSRP value(s) among RSRP values. Here, the given value, X, and M are integers, and may be defined by a specification or may be indicated by an SIB/RRC IE. Otherwise, the UE may transmit PRACH repetitions using the same beam.

### {Choice 3-7}

The transmission method may be based on a combination of Example 1 and Example 2.

The UE may first determine, based on Example 1, whether to transmit PRACH repetitions using the same beam. If the PRACH repetitions using the using the same beam are not selected, the UE may determine, based on Example 2, whether to transmit PRACH repetitions using a plurality of different beams.

The UE may first determine, based on Example 2, whether to transmit PRACH repetitions using a plurality of different beams. If the PRACH repetitions using a plurality of different beams are not selected, the UE may determine, based on Example 1, whether to transmit PRACH repetitions using the using the same beam.

### {Choice 3-8}

The transmission method may be based on priorities for PRACH repetitions using the using the same beam and PRACH repetitions using a plurality of different beams.

The priorities for the two repetition schemes (PRACH repetitions using the using the same beam and PRACH repetitions using a plurality of different beams) may be defined by a specification or may be indicated by the base station (via an SIB/RRC IE/PDCCH order). For example, a priority of the PRACH repetitions using a plurality of different beams may be higher or lower than a priority of the PRACH repetitions using the using the same beam.

In one RACH attempt, if the RACH attempt is the first (or first to X th) RACH attempt(s) in current RACH procedure (value of PREAMBLE_TRANSMISSION_COUNTER is 0 (or less than X)) or if the UE has not transmitted a plurality of PRACH repetitions in any previous X (consecutive) RACH attempts in the RACH procedure, the UE may determine to apply, in the RACH attempts, a repetition scheme with a higher priority. A value of X may be defined by a specification or may be indicated by an SIB/RRC IE/PDCCH order. The value of X may be any integer greater than or equal to 1.

When the priority of the PRACH repetitions using the using the same beam is higher than the priority of the PRACH repetitions using a plurality of different beams, the UE may determine, based on Example 2, whether to perform PRACH repetitions using a plurality of different beams.

When the priority of the PRACH repetitions using a plurality of different beams is higher than the priority of the PRACH repetitions using the using the same beam, the UE may determine, based on Example 1, whether to perform PRACH repetitions using the using the same beam.

In one RACH attempt, if the UE has transmitted a plurality of PRACH repetitions in any previous X (consecutive) RACH attempts in the RACH procedure and the RACH attempts have failed, the UE may follow one of the following some operations. A value of X may be defined by a specification or may be indicated by an SIB/RRC IE/PDCCH order. The value of X may be any integer greater than or equal to 1.

### {{Operation A}}

The UE performs, in the RACH attempts, a plurality of PRACH repetitions by using a repetition scheme with a lower priority.

When the priority of the PRACH repetitions using the using the same beam is higher than the priority of the PRACH repetitions using a plurality of different beams, the UE has transmitted a plurality of PRACH repetitions using the using the same beam in the previous RACH attempts, and the RACH attempts have failed, the UE may transmit a plurality of PRACH repetitions using a plurality of different beams.

When the priority of the PRACH repetitions using a plurality of different beams is higher than the priority of the PRACH repetitions using the using the same beam, the UE has transmitted a plurality of PRACH repetitions using a plurality of different beams in the previous RACH attempts, and the RACH attempts have failed, the UE may transmit a plurality of PRACH repetitions using the using the same beam.

### {{Operation B}}

The UE determines whether to apply, in the RACH attempt, a repetition scheme with a lower priority.

When the priority of the PRACH repetitions using the using the same beam is higher than the priority of the PRACH repetitions using a plurality of different beams, the UE has transmitted a plurality of PRACH repetitions using the using the same beam in the previous RACH attempts, and the RACH attempts have failed, the UE may determine, based on Example 2, whether to transmit a plurality of PRACH repetitions using a plurality of different beams.

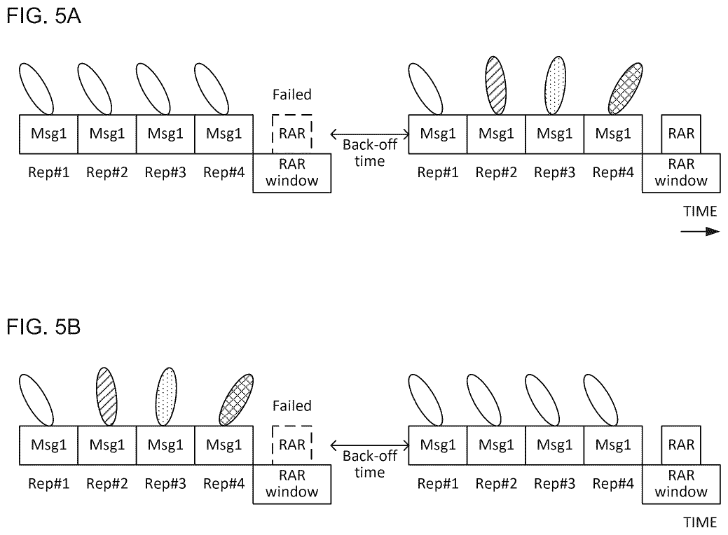

In an example in FIG. 5A, the priority of the PRACH repetitions using the using the same beam is higher than the priority of the PRACH repetitions using a plurality of different beams, the UE has transmitted a plurality of PRACH repetitions using the using the same beam in the previous RACH attempts, and the UE has failed to receive an RAR. The UE may transmit, in a subsequent RACH attempt, a plurality of PRACH repetitions using a plurality of different beams.

When the priority of the PRACH repetitions using a plurality of different beams is higher than the priority of the PRACH repetitions using the using the same beam, the UE has transmitted a plurality of PRACH repetitions using a plurality of different beams in the previous RACH attempts, and the RACH attempts have failed, the UE may determine, based on Example 1, whether to transmit a plurality of PRACH repetitions using the using the same beam.

In an example in FIG. 5B, the priority of the PRACH repetitions using a plurality of different beams is higher than the priority of the PRACH repetitions using the using the same beam, the UE has transmitted a plurality of PRACH repetitions using a plurality of different beams in the previous RACH attempts, and the UE has failed to receive an RAR. The UE may transmit, in a subsequent RACH attempt, a plurality of PRACH repetitions using the using the same beam.

### {Choice 3-9}

The transmission method may be based on a UE capability for beam correspondence. If the UE does not have/report the capability for beam correspondence, the UE may transmit PRACH repetitions using a plurality of different beams. If the UE has/reports the capability for beam correspondence, the UE may determine, based on Example 1, whether to transmit a PRACH without repetitions or PRACH repetitions using the using the same beam.

A combination of at least two of Choices 3-1 to 3-9 may be used.

### Example 4

This example relates to how the UE determines a transmission method/transmission scheme for whether to transmit a PRACH without repetitions, PRACH repetitions using the using the same beam, PRACH repetitions using a plurality of different beams, or PRACH repetitions using the using the same beam and a plurality of different beams (one transmission method from among the four transmission methods). This example may correspond to Case 9.

### {Choice 4-0}

The transmission method may be defined by a specification. The specification may define that the UE always transmits PRACH repetitions using the using the same beam, the UE always transmits PRACH repetitions using a plurality of different beams (and the number of beams), the UE always transmits PRACH repetitions using the using the same beam and a plurality of different beams (and the number of beams), or the UE always transmits a PRACH without repetitions.

### {Choice 4-1}

The transmission method may be indicated by an SIB/RRC IE/PDCCH order (for PDCCH ordered RACH procedure). The base station may indicate, by using the SIB/RRC IE/PDCCH order, one transmission method from among the four transmission methods (and the number of repetitions/number of beams in a case of a plurality of PRACH repetitions).

### {Choice 4-2}

The transmission method may be based on a RACH triggering method/RACH purpose. The RACH triggering method may be a method in which a RACH is started by a PDCCH order/MAC entity/RRC. The RACH purpose may be initial access/system information (SI) request/SpCell BFR/reconfiguration with synchronization (reconfiguration with sync).

Relationship/mapping between whether to transmit a PRACH without repetitions, PRACH repetitions using the using the same beam (and the number of repetitions), PRACH repetitions using a plurality of different beams (and the number of repetitions/number of beams), or PRACH repetitions using the using the same beam and a plurality of different beams (and the number of repetitions per beam) and the RACH triggering method/RACH purpose may be defined by a specification or may be configured by an SIB/RRC IE.

### {Choice 4-3}

The transmission method may be based on an RO configuration parameter. The RO configuration parameter may be at least one of a PRACH configuration index, a PRACH format, the number of SSBs per RO, the number of PRACH transmission occasions FDMed in one time instance, the number of PRACH slots in one subframe, the number of time domain PRACH occasions in one PRACH slot, PRACH duration, zeroCorrelationZoneConfig (configuration of the number of cyclic shifts), and a total number of preambles (for PRACH repetitions using the using the same beam/plurality of different beams).

Relationship/mapping between whether to transmit a PRACH without repetitions, PRACH repetitions using the using the same beam (and the number of repetitions), PRACH repetitions using a plurality of different beams (and the number of repetitions/number of beams), or PRACH repetitions using the using the same beam and a plurality of different beams (and the number of repetitions per beam) and the RO configuration parameter may be defined by a specification or may be configured by an SIB/RRC IE.

### {Choice 4-4}

The transmission method may be based on PREAMBLE_TRANSMISSION_COUNTER.

Whether to transmit a PRACH without repetitions, PRACH repetitions using the using the same beam (and the number of repetitions), PRACH repetitions using a plurality of different beams (and the number of repetitions/number of beams), or PRACH repetitions using the using the same beam and a plurality of different beams (and the number of repetitions per beam) may correspond to different ranges of values of PREAMBLE_TRANSMISSION_COUNTER. Relationship/mapping between the four transmission methods and the range may be defined by a specification or may be configured by an SIB/RRC IE. For example, the mapping may associate one transmission method from among the four transmission methods with the RSRP based value greater/less than a given value.

When PREAMBLE_TRANSMISSION_COUNTER is greater than or equal to X0/less than X1, the UE may transmit a PRACH without repetitions. When PREAMBLE_TRANSMISSION_COUNTER is greater than or equal to X2/less than X3, the UE may transmit PRACH repetitions using the using the same beam. The number of PRACH repetitions may be determined based on PREAMBLE_TRANSMISSION_COUNTER. For example, when Y0<(or ≤) PREAMBLE_TRANSMISSION_COUNTER <(or ≤) Y1, the number of PRACH repetitions may be N1. When PREAMBLE_TRANSMISSION_COUNTER is greater than or equal to X4/less than X5, the UE may transmit PRACH repetitions using a plurality of different beams. The number of PRACH repetitions/number of beams may be determined based on PREAMBLE_TRANSMISSION_COUNTER. For example, when Y2<(or ≤) PREAMBLE_TRANSMISSION_COUNTER <(or ≤) Y3, the number of PRACH repetitions/number of beams may be N2. When PREAMBLE_TRANSMISSION_COUNTER is greater than or equal to X6/less than X7, the UE may transmit PRACH repetitions using the using the same beam and a plurality of different beams. At least one of the number of beams, the number of PRACH repetitions for each beam, and a total number of PRACH repetitions may be determined based on PREAMBLE_TRANSMISSION_COUNTER. For example, when Y4<(or ≤) PREAMBLE_TRANSMISSION_COUNTER <(or ≤) Y5, the number of PRACH beams and the total number of PRACH repetitions may be N3 and N4, respectively.

### {Choice 4-5}

The transmission method may be based on a value configured for a random access limit parameter (at least one of preambleTransMax, ra-ResponseWindow, and ra-ContentionResolutionTimer).

Whether to transmit a PRACH without repetitions, PRACH repetitions using the using the same beam (and the number of repetitions), PRACH repetitions using a plurality of different beams (and the number of repetitions/number of beams), or PRACH repetitions using the using the same beam and a plurality of different beams (and the number of repetitions per beam) may correspond to different ranges of values of the random access limit parameter. Relationship/mapping between the four transmission methods and the range may be defined by a specification or may be configured by an SIB/RRC IE. For example, the mapping may associate one transmission method from among the four transmission methods with the RSRP based value greater/less than a given value.

The UE may transmit a PRACH without repetitions in at least one of a case where preambleTransMax is greater than or equal to X0/less than X1, a case where ra-ResponseWindow is greater than or equal to Y0/less than Y1, and a case where ra-ContentionResolutionTimer is greater than or equal to Z0/less than Z1. The UE may transmit PRACH repetitions using the using the same beam in at least one of a case where preambleTransMax is greater than or equal to X2/less than X3, a case where ra-ResponseWindow is greater than or equal to Y2/less than Y3, and a case where ra-ContentionResolutionTimer is greater than or equal to Z2/less than Z3. The UE may transmit PRACH repetitions using a plurality of different beams in at least one of a case where preambleTransMax is greater than or equal to X4/less than X5, a case where ra-ResponseWindow is greater than or equal to Y4/less than Y5, and a case where ra-ContentionResolutionTimer is greater than or equal to Z4/less than Z5. The UE may transmit PRACH repetitions using the using the same beam and a plurality of different beams in at least one of a case where preambleTransMax is greater than or equal to X6/less than X7, a case where ra-ResponseWindow is greater than or equal to Y6/less than Y7, and a case where ra-ContentionResolutionTimer is greater than or equal to Z6/less than Z7.

At least one of the number of beams, the number of PRACH repetitions per beam, and a total number of PRACH repetitions may or may not depend on the random access limit parameter.

### {Choice 4-6}

The transmission method may be based on RSRP for one or more receptions of SSB(s) or CSI-RS(s).

The UE may determine one transmission method from among the four transmission methods (and the number of repetitions/number of beams in a case of a plurality of PRACH repetitions), based on at least one of an RSRP value of an SSB/CSI-RS selected (in accordance with a rule in Rel. 15/16/17), a range of values of an RSRP gap, all the RSRP values (or RSRP values exceeding rsrp-ThresholdSSB or the top N highest RSRP values), a highest value/lowest value/average value/standard deviation of all the RSRP values (or RSRP values exceeding rsrp-ThresholdSSB or the top N highest RSRP values), and the number of RSRP values in a given range. The gap may be a gap between RSRP of the selected SSB/CSI-RS and the highest RSRP value among all the RSRP values or an averaged RSRP value of all the RSRP values (or an RSRP value exceeding rsrp-ThresholdSSB, from among the top N highest RSRP values). At least one of the four transmission methods may correspond to a range of values of the gap. Relationship/mapping of the correspondence may be defined by a specification or may be indicated by an SIB/RRC IE. For example, the mapping may associate one transmission method from among the four transmission methods with the gap greater/less than a given value.

When reception of more than N SSBs/CSI-RSs with RSRP higher than X1 is present and the highest RSRP is lower than X2, the UE may transmit a plurality of PRACH repetitions using a plurality of different beams, and may transmit a plurality of repetitions on each beam or some of the plurality of different beams.

When reception of more than N SSBs/CSI-RSs with RSRP higher than X3 is present, the UE may transmit a plurality of PRACH repetitions using a plurality of different beams.

When reception of only one SSB/CSI-RS with RSRP higher than X1 is present and the highest RSRP is lower than X2, the UE may transmit a plurality of PRACH repetitions using the same plurality of beams.

### {Choice 4-7}

The transmission method may be based on a combination of Example 1 and Example 2.

The UE may use Example 1/Example 2 to determine which of the using the same beam, a plurality of different beams, or the using the same beam and a plurality of different beams is to be applied to a plurality of repetitions.

The UE may apply Example 1 (determine whether PRACH repetitions using the using the same beam are necessary), and may subsequently apply Example 2 (determine whether PRACH repetitions using a plurality of different beams are necessary). The UE may follow the following some steps.

{{Step 1}} The UE may determine, based on Example 1, whether to transmit PRACH repetitions using the using the same beam.
{{Step 2}} The UE may determine, based on Example 2, whether to transmit PRACH repetitions using a plurality of different beams.

The UE may follow at least one of the following some cases.
When PRACH repetitions using the using the same beam are not selected based on Example 1, and PRACH repetitions using a plurality of different beams are not selected based on Example 2, the UE may transmit a PRACH without repetitions.
When PRACH repetitions using the using the same beam are not selected based on Example 1, and PRACH repetitions using a plurality of different beams are selected based on Example 2, the UE may transmit PRACH repetitions using a plurality of different beams.
When PRACH repetitions using the using the same beam are selected based on Example 1, and PRACH repetitions using a plurality of different beams are not selected based on Example 2, the UE may transmit PRACH repetitions using the using the same beam.
When PRACH repetitions using the using the same beam are selected based on Example 1, and PRACH repetitions using a plurality of different beams are selected based on Example 2, the UE may transmit PRACH repetitions using the using the same beam and a plurality of different beams.

The UE may apply Example 2 (determine whether PRACH repetitions using a plurality of different beams are necessary), and may subsequently apply Example 1 (determine whether PRACH repetitions using the using the same beam are necessary). The UE may follow the following some steps.

{{Step 1}} The UE may determine, based on Example 2, whether to transmit PRACH repetitions using a plurality of different beams.
{{Step 2}} For each of the PRACH repetition transmission beams determined in Step 1, the UE may determine, based on Example 1, whether PRACH repetitions using the beam are necessary.

The UE may follow at least one of the following some cases.
When PRACH repetitions using a plurality of different beams are not selected based on Example 2, and PRACH repetitions using the using the same beam are not selected based on Example 1, the UE may transmit a PRACH without repetitions.
When PRACH repetitions using a plurality of different beams are not selected based on Example 2, and PRACH repetitions using the using the same beam are selected based on Example 1, the UE may transmit PRACH repetitions using the using the same beam.
In a case where PRACH repetitions using a plurality of different beams are selected based on Example 2, the UE may follow, for each of the determined plurality of beams, at least one of (a) and (b) below.
   (a) When PRACH repetitions using the using the same beam are selected based on Example 1, the UE may transmit a plurality of repetitions on the beam.
   (b) When PRACH repetitions using the using the same beam are not selected based on Example 1, the UE may transmit only one repetition on the beam.

### {Choice 4-8}

The transmission method may be based on priorities for PRACH repetitions using the using the same beam and PRACH repetitions using a plurality of different beams.

The priorities for the two repetition schemes (PRACH repetitions using the using the same beam and PRACH repetitions using a plurality of different beams) may be defined by a specification or may be indicated by the base station (via an SIB/RRC IE/PDCCH order). For example, a priority of the PRACH repetitions using a plurality of different beams may be higher or lower than a priority of the PRACH repetitions using the using the same beam.

In one RACH attempt, if the RACH attempt is the first (or first to X th) RACH attempt(s) in current RACH procedure (value of PREAMBLE_TRANSMISSION_COUNTER is 0 (or less than X)) or if the UE has not transmitted a plurality of PRACH repetitions in any previous X (consecutive) RACH attempts in the RACH procedure, the UE may determine to apply, in the RACH attempts, a repetition scheme with a higher priority. A value of X may be defined by a specification or may be indicated by an SIB/RRC IE/PDCCH order. The value of X may be any integer greater than or equal to 1.

When the priority of the PRACH repetitions using the using the same beam is higher than the priority of the PRACH repetitions using a plurality of different beams, the UE may determine, based on Example 2, whether to perform PRACH repetitions using a plurality of different beams.

When the priority of the PRACH repetitions using a plurality of different beams is higher than the priority of the PRACH repetitions using the using the same beam, the UE may determine, based on Example 1, whether to perform PRACH repetitions using the using the same beam.

In one RACH attempt, if the UE has transmitted a plurality of PRACH repetitions in any previous X (consecutive) RACH attempts in the RACH procedure and the RACH attempts have failed, the UE may follow one of the following some operations. A value of X may be defined by a specification or may be indicated by an SIB/RRC IE/PDCCH order. The value of X may be any integer greater than or equal to 1.

### {{Operation A}}

The UE performs, in the RACH attempts, a plurality of PRACH repetitions by using a repetition scheme with a lower priority.

When the priority of the PRACH repetitions using the using the same beam is higher than the priority of the PRACH repetitions using a plurality of different beams, the UE has transmitted a plurality of PRACH repetitions using the using the same beam in the previous RACH attempts, and the RACH attempts have failed, the UE may transmit a plurality of PRACH repetitions using a plurality of different beams.

When the priority of the PRACH repetitions using a plurality of different beams is higher than the priority of the PRACH repetitions using the using the same beam, the UE has transmitted a plurality of PRACH repetitions using a plurality of different beams in the previous RACH attempts, and the RACH attempts have failed, the UE may transmit a plurality of PRACH repetitions using the using the same beam.

If the UE has transmitted a plurality of PRACH repetitions with a higher priority in any previous X (consecutive) RACH attempts in the RACH procedure, the RACH attempts have failed, the UE has transmitted a plurality of PRACH repetitions with a lower priority in any previous Y (consecutive) RACH attempts in the RACH procedure, and the RACH attempts have failed, the UE may transmit a plurality of PRACH repetitions using the using the same beam and a plurality of different beams.

### {{Operation B}}

The UE may transmit, in the RACH attempts, a plurality of PRACH repetitions using the using the same beam and a plurality of different beams.

When the priority of the PRACH repetitions using the using the same beam is higher than the priority of the PRACH repetitions using a plurality of different beams, the UE has transmitted a plurality of PRACH repetitions using the using the same beam in the previous RACH attempts, and the RACH attempts have failed, the UE may transmit a plurality of PRACH repetitions using the using the same beam and a plurality of different beams.

When the priority of the PRACH repetitions using a plurality of different beams is higher than the priority of the PRACH repetitions using the using the same beam, the UE has transmitted a plurality of PRACH repetitions using a plurality of different beams in the previous RACH attempts, and the RACH attempts have failed, the UE may transmit a plurality of PRACH repetitions using the using the same beam and a plurality of different beams.

### {{Operation C}}

The UE determines whether to apply, in the RACH attempts, a repetition scheme with a lower priority.

When the priority of the PRACH repetitions using the using the same beam is higher than the priority of the PRACH repetitions using a plurality of different beams, the UE has transmitted a plurality of PRACH repetitions using the using the same beam in the previous RACH attempts, and the RACH attempts have failed, the UE may determine, based on Example 2, whether to transmit a plurality of PRACH repetitions using a plurality of different beams.

When the priority of the PRACH repetitions using a plurality of different beams is higher than the priority of the PRACH repetitions using the using the same beam, the UE has transmitted a plurality of PRACH repetitions using a plurality of different beams in the previous RACH attempts, and the RACH attempts have failed, the UE may determine, based on Example 1, whether to transmit a plurality of PRACH repetitions using the using the same beam.

If the UE has transmitted a plurality of PRACH repetitions with a higher priority in any previous X (consecutive) RACH attempts in the RACH procedure, the RACH attempts have failed, the UE has transmitted a plurality of PRACH repetitions with a lower priority in any previous Y (consecutive) RACH attempts in the RACH procedure, and the RACH attempts have failed, the UE may transmit a plurality of PRACH repetitions using the using the same beam and a plurality of different beams.

### {{Operation D}}

The UE may determine whether to transmit, in the RACH attempts, a plurality of PRACH repetitions using the using the same beam and a plurality of different beams.

When the priority of the PRACH repetitions using the using the same beam is higher than the priority of the PRACH repetitions using a plurality of different beams, the UE has transmitted a plurality of PRACH repetitions using the using the same beam in the previous RACH attempts, and the RACH attempts have failed, the UE may determine, based on Example 2, whether to transmit a plurality of PRACH repetitions using a plurality of different beams. In this case, the UE may follow at least one of Operations D-1 and D-2 below.

### {{{Operation D-1}}}

If it is determined that the plurality of PRACH repetitions using a plurality of different beams are transmitted, the UE transmits a plurality of PRACH repetitions using the using the same beam and a plurality of different beams. Otherwise, the UE transmits a plurality of PRACH repetitions using the using the same beam.

### {{{Operation D-2}}}

If it is determined that the plurality of PRACH repetitions using a plurality of different beams are transmitted, the UE transmits a plurality of PRACH repetitions using the using the same beam and a plurality of different beams. Otherwise, the UE transmits a PRACH without repetitions.

When the priority of the PRACH repetitions using a plurality of different beams is higher than the priority of the PRACH repetitions using the using the same beam, the UE has transmitted a plurality of PRACH repetitions using a plurality of different beams in the previous RACH attempts, and the RACH attempts have failed, the UE may determine, based on Example 1, whether to transmit a plurality of PRACH repetitions using the using the same beam. In this case, the UE may follow at least one of Operations D-3 and D-4 below.

### {{{Operation D-3}}}

If it is determined that the plurality of PRACH repetitions using the using the same beam are transmitted, the UE transmits a plurality of PRACH repetitions using the using the same beam and a plurality of different beams. Otherwise, the UE transmits a plurality of PRACH repetitions using a plurality of different beams.

### {{{Operation D-4}}}

If it is determined that the plurality of PRACH repetitions using the using the same beam are transmitted, the UE transmits a plurality of PRACH repetitions using the using the same beam and a plurality of different beams. Otherwise, the UE transmits a PRACH without repetitions.

If the UE has transmitted a plurality of PRACH repetitions with a higher priority in any previous X (consecutive) RACH attempts in the RACH procedure, the RACH attempts have failed, the UE has transmitted a plurality of PRACH repetitions with a lower priority in any previous Y (consecutive) RACH attempts in the RACH procedure, and the RACH attempts have failed, the UE may transmit a plurality of PRACH repetitions using the using the same beam and a plurality of different beams.

Concrete examples of Operation A/C will be described below.

In an example in FIG. 6, the priority of the PRACH repetitions using the using the same beam is higher than the priority of the PRACH repetitions using a plurality of different beams, the UE has transmitted a plurality of PRACH repetitions using the using the same beam in the previous RACH attempts, and the UE has failed to receive an RAR. The UE may transmit, in a subsequent RACH attempt, a plurality of PRACH repetitions using a plurality of different beams.

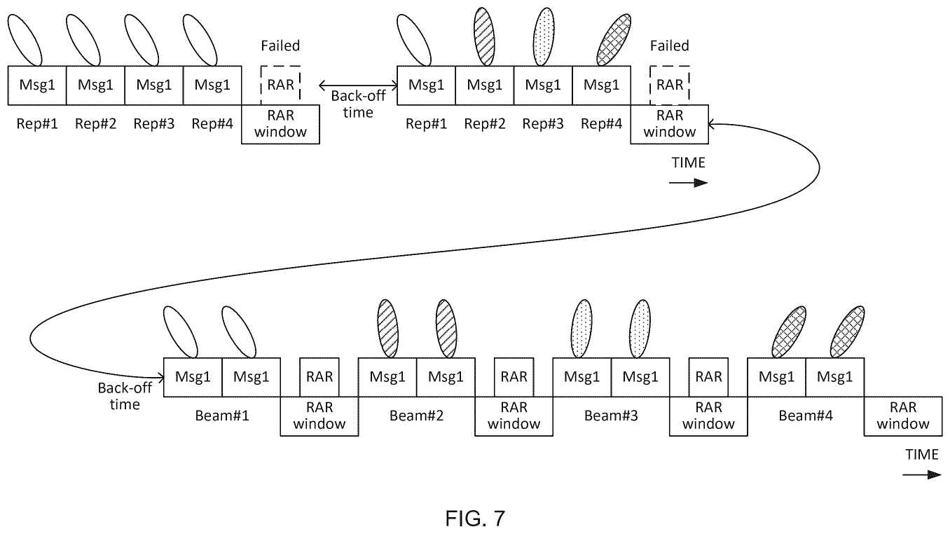

In an example in FIG. 7, the UE has, furthermore, failed to receive an RAR in the second RACH attempt. The UE may transmit, in a subsequent RACH attempt, a plurality of PRACH repetitions using the using the same beam and a plurality of different beams.

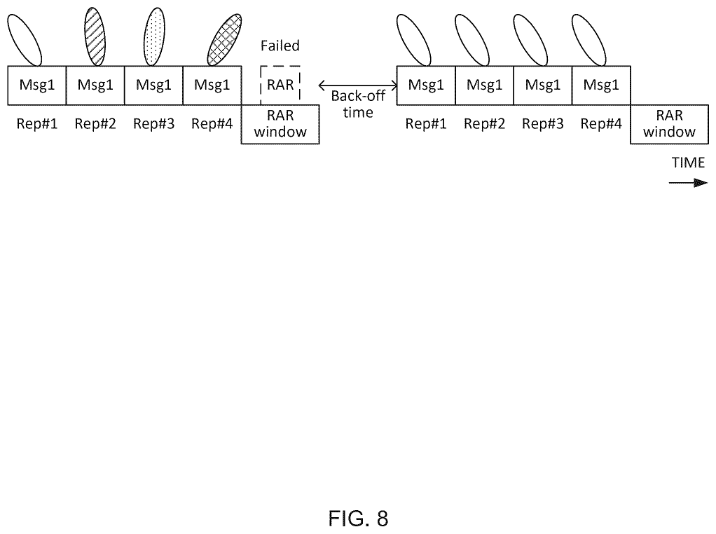

In an example in FIG. 8, the priority of the PRACH repetitions using a plurality of different beams is higher than the priority of the PRACH repetitions using the using the same beam, the UE has transmitted a plurality of PRACH repetitions using a plurality of different beams in the previous RACH attempts, and the UE has failed to receive an RAR. The UE may transmit, in a subsequent RACH attempt, a plurality of PRACH repetitions using the using the same beam.

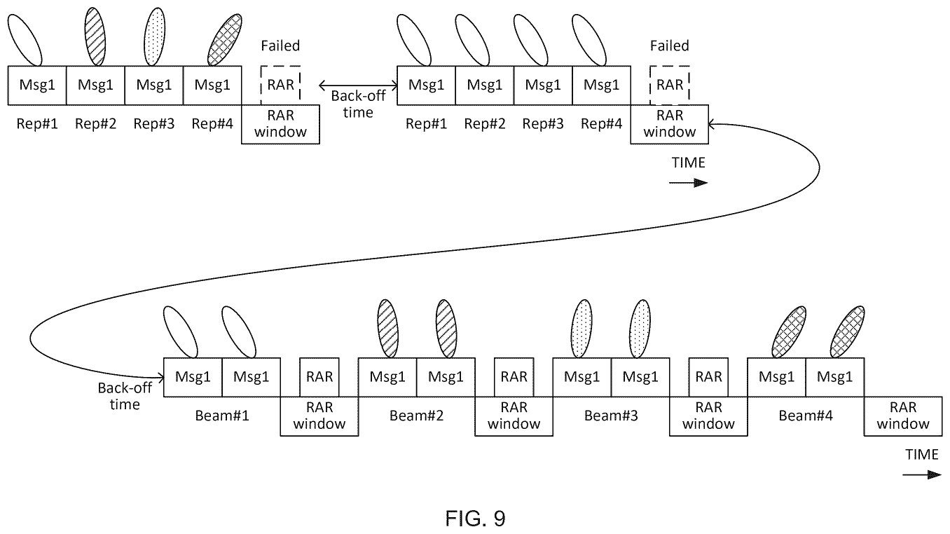

In an example in FIG. 9, the UE has, furthermore, failed to receive an RAR in the second RACH attempt. The UE may transmit, in a subsequent RACH attempt, a plurality of PRACH repetitions using the using the same beam and a plurality of different beams.

Concrete examples of Operation B/D will be described below.

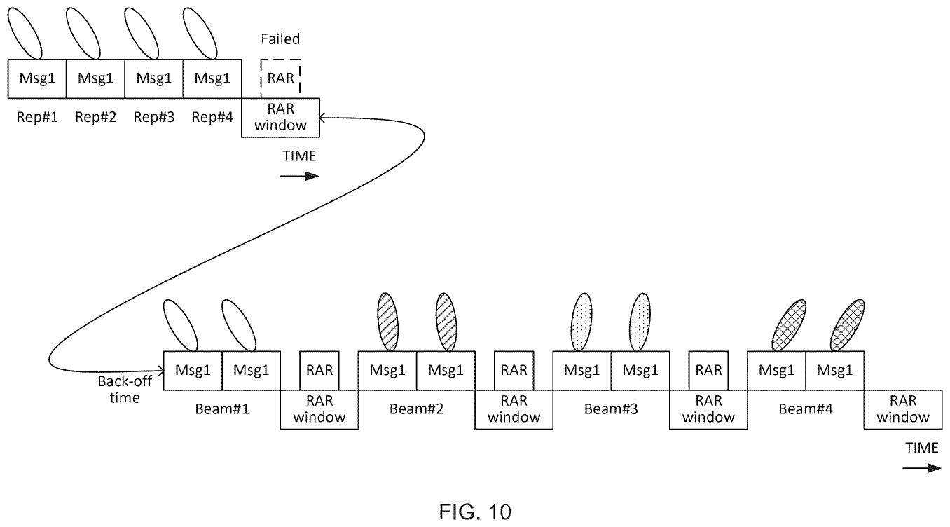

In an example in FIG. 10, the priority of the PRACH repetitions using the using the same beam is higher than the priority of the PRACH repetitions using a plurality of different beams, the UE has transmitted a plurality of PRACH repetitions using the using the same beam in the previous RACH attempts, and the UE has failed to receive an RAR. The UE may transmit, in a subsequent RACH attempt, a plurality of PRACH repetitions using the using the same beam and a plurality of different beams.

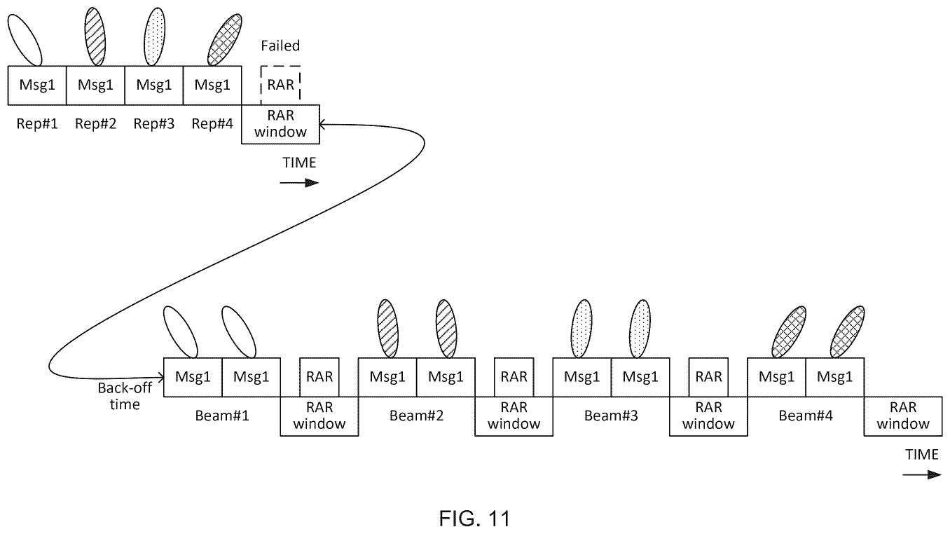

In an example in FIG. 11, the priority of the PRACH repetitions using a plurality of different beams is higher than the priority of the PRACH repetitions using the using the same beam, the UE has transmitted a plurality of PRACH repetitions using a plurality of different beams in the previous RACH attempts, and the UE has failed to receive an RAR. The UE may transmit, in a subsequent RACH attempt, a plurality of PRACH repetitions using the using the same beam and a plurality of different beams.

### {Choice 4-9}

The transmission method may be based on a UE capability for beam correspondence.

If the UE does not have/report the capability for beam correspondence, the UE may transmit PRACH repetitions using a plurality of different beams. The UE may determine, based on Example 1, whether to transmit PRACH repetitions using the using the same beam (for each of the plurality of different beams). If it is determined that the PRACH repetitions using the using the same beam are transmitted, the UE may transmit PRACH repetitions using the using the same beam and a plurality of different beams. If it is determined that the PRACH repetitions using the using the same beam are not transmitted, the UE may transmit PRACH repetitions using a plurality of different beams.

If the UE has/reports the capability for beam correspondence, the UE may determine, based on Example 1, whether to transmit a PRACH without repetitions or PRACH repetitions using the using the same beam. If it is determined that the PRACH repetitions using the using the same beam are transmitted, the UE may transmit PRACH repetitions using the using the same beam and a plurality of different beams. If it is determined that the PRACH repetitions using the using the same beam are not transmitted, the UE may transmit a PRACH without repetitions.

A combination of at least two of Choices 4-1 to 4-9 may be used.

According to this embodiment, the UE can appropriately determine a PRACH transmission method. The UE can, when performing a plurality of repetitions, appropriately determine a beam to be used for the plurality of repetitions.

### <Supplement>

In random access procedure for initial access, the UE may use a plurality of different beams for a plurality of respective PRACH repetitions.

When RSRP is lower than a threshold value, the UE may use one same beam for a plurality of PRACH repetitions.

### {Notification of Information to UE}

Notification of any information (from a network (NW) (for example, a base station (BS))) to the UE in the above-described embodiment (in other words, reception, in the UE, of any information from the BS) may be performed by using physical layer signaling (for example, DCI), higher layer signaling (for example, RRC signaling or a MAC CE), a specific signal/channel (for example, a PDCCH, a PDSCH, or a reference signal), or combinations or these.

When the notification is performed by the MAC CE, the MAC CE may be identified by inclusion, in a MAC sub-header, of a new logical channel ID (LCID) not defined in an existing specification.

When the notification is performed by the DCI, the notification may be performed by a specific field of the DCI, a radio network temporary identifier (RNTI) used for scrambling of cyclic redundancy check (CRC) bits given to the DCI, a format of the DCI, or the like.

The notification of any information to the UE in the above-described embodiment may be performed periodically, semi-persistently, or aperiodically.

{Notification of Information from UE}

Notification of any information from the UE (to the NW) in the above-described embodiment (in other words, transmission/reporting, in the UE, of any information to the BS) may be performed by using physical layer signaling (for example, UCI), higher layer signaling (for example, RRC signaling or a MAC CE), a specific signal/channel (for example, a PUCCH, a PUSCH, a PRACH, or a reference signal), or combinations or these.

When the notification is performed by the MAC CE, the MAC CE may be identified by inclusion, in a MAC sub-header, of a new LCID not defined in an existing specification.

When the notification is performed by the UCI, the notification may be transmitted by using a PUCCH or a PUSCH.

The notification of any information from the UE in the above-described embodiment may be performed periodically, semi-persistently, or aperiodically.

### {Regarding Employment of Respective Embodiments}

At least one of the above-described embodiments may be employed in a case where a specific condition is satisfied. The specific condition may be defined in a specification or may be notified to the UE/BS by using higher layer signaling/physical layer signaling.

At least one of the above-described embodiments may be employed only in the UE that has reported a specific UE capability or that supports the specific UE capability.

The specific UE capability may indicate at least one of the following:
PRACH repetitions with using the same beam
PRACH repetitions with plurality of different beams
PRACH repetitions with using the same beam and plurality of different beams
Determining whether to transmit PRACH without repetitions or PRACH repetitions with using the same beam/plurality of different beams, based on configuration/indication by SIB/RRC IE
Priority of PRACH repetitions with using the same beam, priority of PRACH repetitions with plurality of different beams; the priority may be defined by a specification or may be configured/indicated by an SIB/RRC IE.

The specific UE capability may be capability applied over all the frequencies (commonly irrespective of frequency), capability per frequency (for example, one or combinations of a cell, a band, a band combination, a BWP, a component carrier, and the like), capability per frequency range (for example, Frequency Range 1 (FR1), FR2, FR3, FR4, FR5, FR2-1, FR2-2), capability per subcarrier spacing (SCS), or capability per Feature Set (FS) or Feature Set Per Component-carrier (FSPC).

The specific UE capability may be capability applied over all the duplex schemes (commonly irrespective of duplex scheme) or capability per duplex scheme (for example, time division duplex (TDD) or frequency division duplex (FDD)).

At least one of the above-described embodiments may be employed when specific information related to the above-described embodiment (or operation for the above-described embodiment) is configured/activated/triggered for the UE by higher layer signaling/physical layer signaling. For example, the specific information may be information indicating enabling of a function for each embodiment, any RRC parameter for specific release (for example, Rel. 18/19), or the like.

When not supporting at least one of the specific UE capabilities or not configured with the specific information, the UE may apply operation of Rel. 15/16, for example.

### (Supplementary Note)

Regarding one embodiment of the present disclosure, the following supplementary notes of the invention will be given.

### {Supplementary Note 1}

A terminal including:
a control section that determines one transmission scheme from among a first transmission scheme for transmitting a physical random access channel (PRACH) without a plurality of repetitions, a second transmission scheme for transmitting the plurality of repetitions by using the using a same beam, a third transmission scheme for transmitting the plurality of repetitions by using a plurality of different beams, and a fourth transmission scheme for transmitting the plurality of repetitions by using the using a same beam and a plurality of different beams; and
a transmitting section that transmits one or more PRACHs by using the transmission scheme.

### {Supplementary Note 2}

The terminal according to supplementary note 1, wherein the control section determines the transmission scheme, based on at least one of indication of the transmission scheme, a triggering method for random access procedure, a purpose of the random access procedure, configuration of the PRACH, a transmission counter for the PRACH, a limit parameter for the random access procedure, received power of a synchronization signal block and a channel state information reference signal, a priority of at least one of the second transmission scheme and the third transmission scheme, capability information related to beam correspondence, a network type, a duplex scheme, and a frequency range.

### {Supplementary Note 3}

The terminal according to supplementary note 1 or 2, wherein the control section does not report both a capability to use the using the same beam for the plurality of repetitions and a capability to use a plurality of different beams for the plurality of repetitions, does not assume that both use of the using the same beam for the plurality of repetitions and use of a plurality of different beams for the plurality of repetitions are configured, or does not apply both the using the same beam and a plurality of different beams in one random access channel attempt.

### {Supplementary Note 4}

The terminal according to any one of supplementary notes 1 to 3, wherein the control section applies both the using the same beam and a plurality of different beams in one random access channel attempt.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

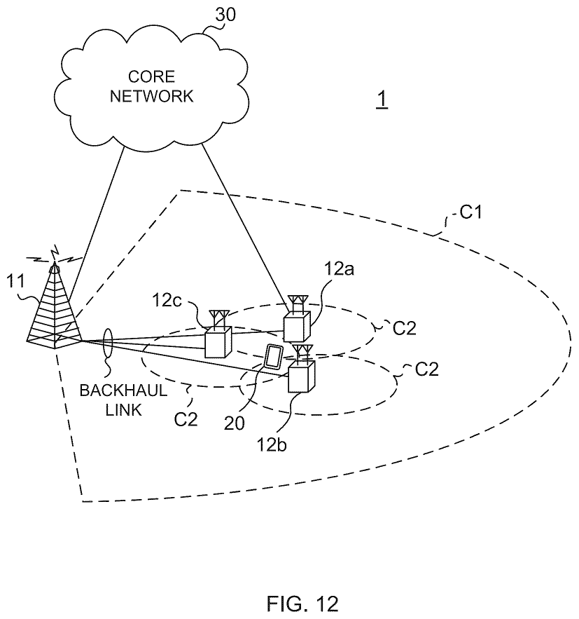

FIG. 12 is a diagram to show an example of a schematic structure of the radio communication system according to one embodiment. The radio communication system 1 (which may be simply referred to as system 1) may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include network functions (NFs), such as User Plane Function (UPF), Access and Mobility management Function (AMF), Session Management Function (SMF), Unified Data Management (UDM), ApplicationFunction (AF), Data Network (DN), Location Management Function (LMF), Maintenance and Operation Management (Operation, Administration and Maintenance (Management) (OAM)), and the like. Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data,” and the PUSCH may be interpreted as “UL data.”

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a given search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

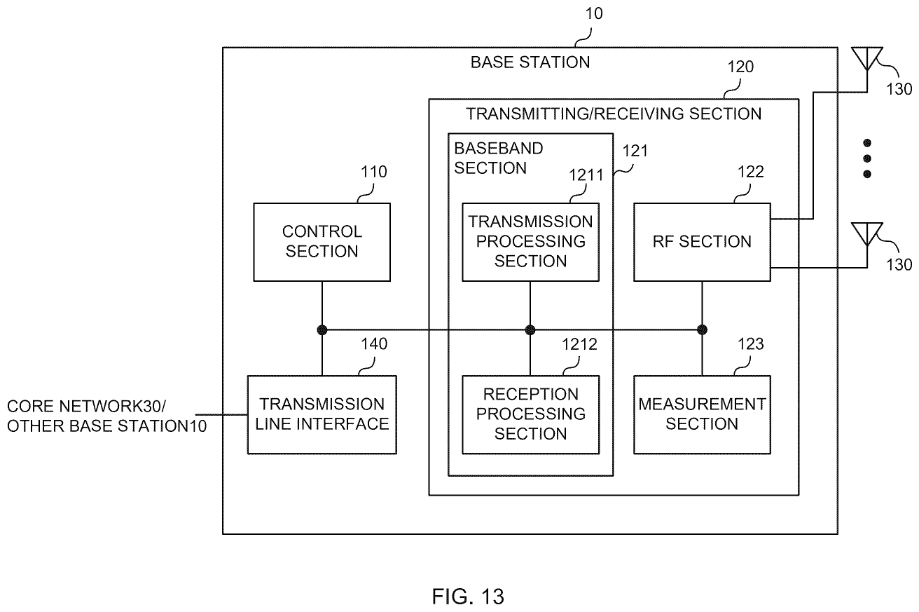

FIG. 13 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212.

The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section.

The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus (for example, a network node for providing NF) included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The control section 110 may determine one transmission scheme from among a first transmission scheme for transmitting a physical random access channel (PRACH) without a plurality of repetitions, a second transmission scheme for transmitting the plurality of repetitions by using the using the same beam, a third transmission scheme for transmitting the plurality of repetitions by using a plurality of different beams, and a fourth transmission scheme for transmitting the plurality of repetitions by using the using the same beam and a plurality of different beams. The transmitting/receiving section 120 may receive one or more PRACHs by using the transmission scheme.

### (User Terminal)

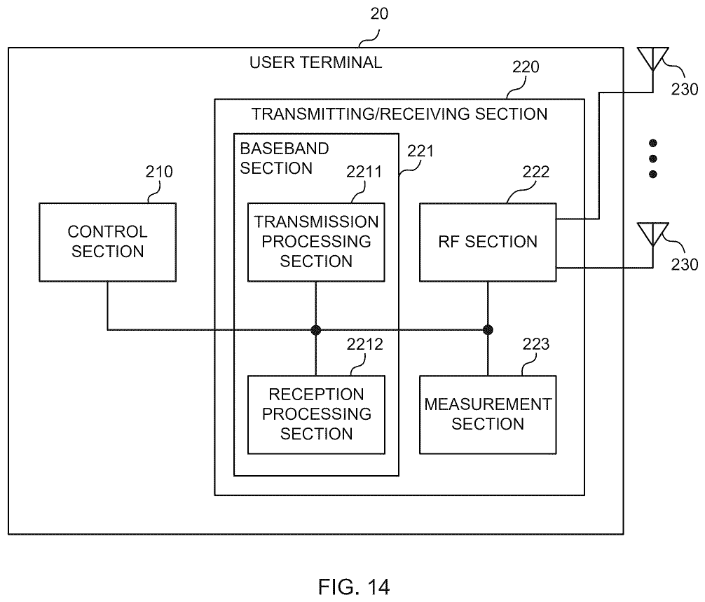

FIG. 14 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section.

The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure received power (for example, RSRP), received quality (for example, RSRQ, SINR, SNR), signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The control section 210 may determine one transmission scheme from among a first transmission scheme for transmitting a physical random access channel (PRACH) without a plurality of repetitions, a second transmission scheme for transmitting the plurality of repetitions by using the using the same beam, a third transmission scheme for transmitting the plurality of repetitions by using a plurality of different beams, and a fourth transmission scheme for transmitting the plurality of repetitions by using the using the same beam and a plurality of different beams. The transmitting/receiving section 220 may transmit one or more PRACHs by using the transmission scheme.

The control section 210 may determine the transmission scheme, based on at least one of indication of the transmission scheme, a triggering method for random access procedure, a purpose of the random access procedure, configuration of the PRACH, a transmission counter for the PRACH, a limit parameter for the random access procedure, received power of a synchronization signal block and a channel state information reference signal, a priority of at least one of the second transmission scheme and the third transmission scheme, capability information related to beam correspondence, a network type, a duplex scheme, and a frequency range.

The control section 210 may not report both a capability to use the using the same beam for the plurality of repetitions and a capability to use a plurality of different beams for the plurality of repetitions, may not assume that both use of the using the same beam for the plurality of repetitions and use of a plurality of different beams for the plurality of repetitions are configured, or may not apply both the using the same beam and a plurality of different beams in one random access channel attempt.

The control section 210 may apply both the using the same beam and a plurality of different beams in one random access channel attempt.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

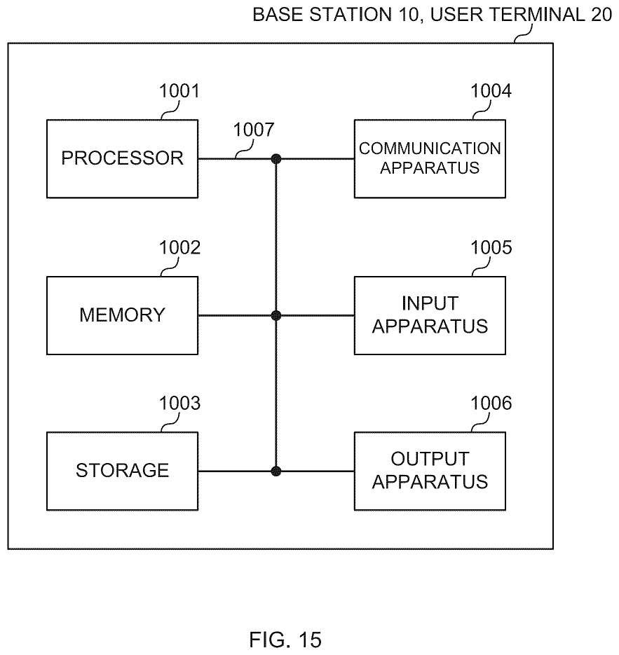

For example, a base station, a user terminal, and so on according to one embodiment of the present disclosure may function as a computer that executes the processes of the radio communication method of the present disclosure. FIG. 15 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for given numerology in a given carrier. Here, a common RB may be specified by an index of the RB based on the common reference point of the carrier. A PRB may be defined by a given BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be specified by given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of given information (for example, reporting of “X holds”) does not necessarily have to be reported explicitly, and can be reported implicitly (by, for example, not reporting this given information or reporting another piece of information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, a case that a base station transmits information to a terminal may be interpreted as a case that the base station indicates, for the terminal, control/operation based on the information, and vice versa.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type).

Note that at least one of a base station and a mobile station also includes an apparatus which does not necessarily move during communication operation. For example, at least one of a base station and a mobile station may be an Internet of Things (IoT) device such as a sensor.

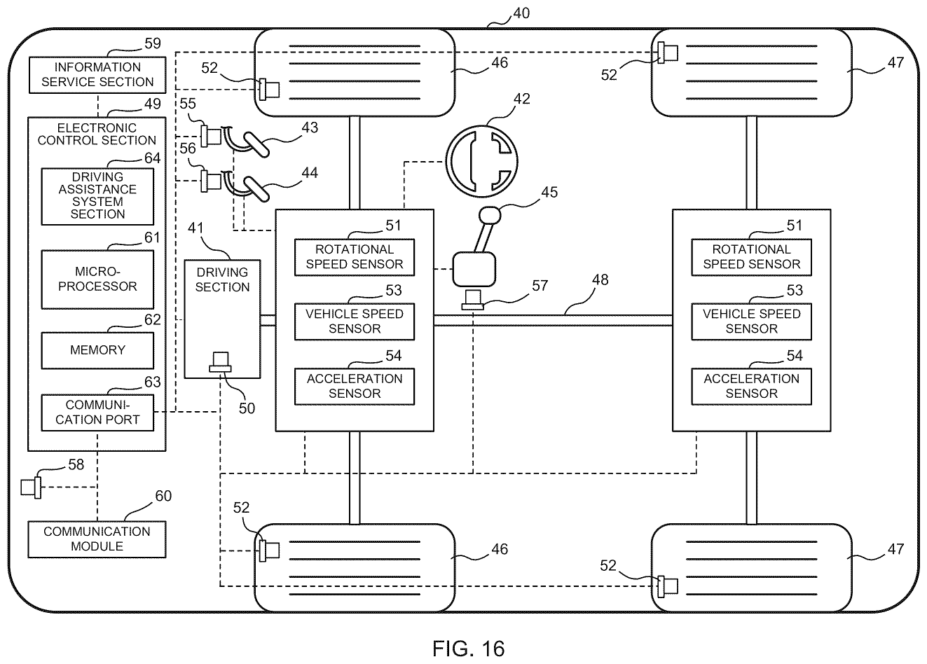

FIG. 16 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B are each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

In the present disclosure, “equal to or smaller than,” “smaller than,” “equal to or larger than,” “larger than,” “equal to,” and the like may be interchangeably interpreted. In the present disclosure, words such as “good,” “poor,” “large,” “small,” “high,” “low,” “early,” “late,” “wide,” “narrow,” and the like may be interchangeably interpreted irrespective of positive degree, comparative degree, and superlative degree. In the present disclosure, expressions obtained by adding “i-th” (i is any integer) to words such as “good,” “poor,” “large,” “small,” “high,” “low,” “early,” “late,” “wide,” “narrow,” and the like may be interchangeably interpreted irrespective of positive degree, comparative degree, and superlative degree (for example, “highest” may be interpreted as “i-th highest,” and vice versa).

In the present disclosure, “of,” “for,” “regarding,” “related to,” “associated with,” and the like may be interchangeably interpreted.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1-6. (canceled)

7. A terminal comprising:
a receiver that receives a reference signal; and
a processor that determines, based on a received power of the reference signal, whether to perform repetitive transmissions of a physical random access channel (PRACH) or to perform a PRACH transmission without the repetitive transmissions.

8. The terminal according to claim 7, wherein the processor controls a number of repetitions of the repetitive transmissions based on a value of a counter regarding a failure of a random access procedure including the repetitive transmissions.

9. The terminal according to claim 7, wherein the repetitive transmissions of the PRACH use a same spatial domain filter in multiple PRACH occasions.

10. The terminal according to claim 9, wherein the multiple PRACH occasions are associated with a same synchronization signal block (SSB) index.

11. A radio communication method for a terminal, comprising:
receiving a reference signal; and
determining, based on a received power of the reference signal, whether to perform repetitive transmissions of a physical random access channel (PRACH) or to perform a PRACH transmission without the repetitive transmissions.

12. A base station comprising:
a transmitter that transmits a reference signal; and
a processor that configures a threshold of a received power of the reference signal to a terminal, the threshold being used to determine whether repetitive transmissions of a physical random access channel (PRACH) are performed or a PRACH transmission without the repetitive transmissions is performed.

13. A system comprising a terminal and a base station, wherein the terminal comprises:
a receiver that receives a reference signal; and
a processor that determines, based on a received power of the reference signal, whether to perform repetitive transmissions of a physical random access channel (PRACH) or to perform a PRACH transmission without the repetitive transmissions, and the base station comprises:
a transmitter that transmits the reference signal.
